(19) United States
(12) Patent Application Publication
(10) Pub. No.: US 2011/0203533 A1
(43) Pub. Date: Aug. 25, 2011

(54) Flat, braided, omnidirectionally reflective collar and leash

(76) Inventor: Marni Markell Hurwitz, Far Hills, NJ (US)

(21) Appl. No.: 12/931,813

(22) Filed: Feb. 11, 2011

Related U.S. Application Data
(63) Continuation-in-part of application No. 12/381,974, filed on Mar. 18, 2009.
Application No. 12/381,974 is a continuation-in-part of application No. 11/711,995, filed on Feb. 28, 2007, now Pat. No. 7,549,399.
Application No. 11/711,995 is a continuation-in-part of application No. 11/185,059, filed on Jul. 20, 2005, now Pat. No. 7,204,206.
Application No. 11/185,059 is a continuation-in-part of application No. 11/067,442, filed on Feb. 25, 2005, now Pat. No. 6,978,738.
Application No. 11/067,442 is a continuation-in-part of application No. 10/935,687, filed on Sep. 8, 2004, now Pat. No. 6,925,965.
(60) Provisional application No. 60/591,936, filed on Jul. 28, 2004.

(51) Int. Cl. A01K 27/00; B23P 17/04

(52) U.S. Cl. 119/794; 119/796; 119/858; 29/419.1

(57) ABSTRACT

A flexible abrasion resistant omnidirectionally reflective, preferably retractable, flat belt pet leash/pet collar exhibits omnidirectional reflectivity. The omnidirectionally reflective flat belt pet leash reflects an incoming light beam back in the direction from which it emanated. The reflected light beam provides accurate illumination of the pet leash and the location of the pet during dusk or nighttime hours. This reflective pet collar and/or leash is created by forming a substantially flat reflective woven band composed of narrow width reflective strips that comprise woven or knitted reflective threads. A raised, braided, dimensional band is optionally placed atop the substantially flat reflective woven band to further increase reflectivity and visibility thereof. The flexible reflective threads are composed of microsphere retroreflectors coated with water resistant compound and, optionally, a poly-phosphorus material. The collar or leash may alternatively be formed by embedding a plurality of microscopic reflectors into the braided weave of a fabric. Upon being embedded, the microscopic reflectors act like smooth mirrors which operate collectively to provide a reflective medium. Due to the braided weave of the fabric and the presence of the raised, braided dimensional band atop the woven fabric, microscopic reflectors within the dimensional band direct light incident thereon from virtually any angle back to its source.

### CROSS-REFERENCE TO RELATED APPLICATIONS

This application is a continuation-in-part of U.S. application Ser. No. 12/381,974, filed Mar. 18, 2009 which, in turn, is a continuation-in-part of U.S. application Ser. No. 11/711,995, filed Feb. 28, 2007 which, in turn, is a continuation-in-part of U.S. application Ser. No. 11/185,059, filed Jul. 20, 2005 which, in turn, is a continuation-in-part of U.S. application Ser. No. 11/067,442, filed Feb. 25, 2005, now U.S. Pat. No. 6,978,738 which, in turn, is a continuation-in-part of U.S. application Ser. No. 10/935,687, filed Sep. 8, 2004, now U.S. Pat. No. 6,925,965 which, in turn, claims the benefit of Application No. 60/591,936, filed Jul. 28, 2004.

### BACKGROUND OF THE INVENTION

1. Field of the Invention

The present invention relates to pet leashes and collars; and more particularly, to a flat, braided, omnidirectionally reflective collar and leash, preferably abrasion resistant, especially suited for use during dusk or nighttime hours to enhance safety of pets and their owners while walking in the vicinity of land vehicles.

2. Description of the Prior Art

Walking a pet during dusk or nighttime hours can be hazardous in neighborhoods where automobiles are encountered. Illuminating characteristics of the automobile headlamps, generally afford an illumination range of approximately 25 to 50 feet. This illumination range can be significantly reduced by mist or fog, or bends in the road. Despite improvements to vehicle headlights, pets and their owners are oftentimes not recognized by automobile drivers until the distance between the automobile and the pet is small.

Several approaches devised by prior art workers attempt to provide solutions for this hazardous common activity. These approaches include 1) use of pet collars that are illuminated or reflective; 2) use of leashes which are illuminated or reflective; or 3) a combination of both features. None of these solutions suggests indicating the whereabouts of a pet owner, a leash and a pet attached to the leash via omnidirectional reflection.

Various types of illuminated dog collars using bulb or other powered sources are known in the art. These power-illuminated leashes require batteries, light bulbs or other lighting elements, which are not needed for reflective illumination. Accordingly, a detailed discussion thereof is not required.

U.S. Pat. No. 4,173,201 to Chao, et al. discloses an illuminated collar for pets and the like. U.S. Pat. No. 4,513,692 to Kuhnsman, et al. discloses an illuminated pet leash comprising a non-opaque tube that contains one or more bundles of optical fibers. U.S. Pat. No. 4,895,110 to Lo Cascio discloses a pet collar that includes a light source and a power source attached to a strap. U.S. Pat. No. 4,887,552 to Hayden discloses an electrically lighted pet leash that is composed of a transparent, flexible tube containing a string of small electric light bulbs mounted in parallel between two insulated wires. U.S. Pat. No. 5,046,456 to Heyman, et al. discloses an illuminated pet collar in which multiple lights are mounted within a flexible, light-permeable tube that extends about the perimeter of the collar. A housing mounted on one end of the tube contains a circuit and a battery for operating the lights. U.S. Pat. No. 5,140,946 to Pennock, et al. discloses an illuminated pet collar with miniature lights powered by a battery encased within a flexible, pliable, transparent plastic display tube, which are parallel-wired within the display tube. U.S. Pat. No. 5,370,082, to Wade discloses an animal collar that includes illuminating devices, such as light emitting diodes, liquid quartz strips or electric lamps powered by a plurality of solar cells. U.S. Pat. No. 5,429,075 to Passarella, et al. discloses a pet leash and flashlight combination. U.S. Pat. No. 5,523,927 to Gokey discloses an illuminated animal collar light emitting diode placed on the outer exterior of a collar powered by a battery. U.S. Pat. No. 5,535,106, issued to Tangen, discloses a lighted animal collar that includes a plurality of separate light emitting assemblies, or housings, at spaced intervals along the collar. U.S. Pat. No. 5,558,044 to Nasser, Jr. et al. discloses an illuminating leash handle with a flashlight. U.S. Pat. No. 5,630,382 to Barbera, et al. discloses an illuminated pet harness having straps with internal cavities that contain fiber optic cores illuminated by a light bulb. U.S. Pat. No. 5,762,029 to DuBois, et al. discloses a combined retractable leash and flashlight. U.S. Pat. No. 5,850,807 to Keeler discloses an illuminated pet leash, wherein illumination is remotely activated by a pet owner to locate the leash. U.S. Pat. No. 5,967,095 to Greves discloses an electroluminescence-illuminated pet flat leash strap. U.S. Pat. No. 6,170,968 to Caswell discloses a motion activated rotatable illuminator. U.S. Pat. No. 6,289,849 to Macedo, et al. discloses a device for removably attaching a flashlight to a retractable dog leash. U.S. Pat. No. 6,557,498 to Smierciak, et al. discloses a night safety pet illumination marker, with a pet collar having a series of light emitting diodes mounted around the perimeter of the collar and powered by battery power.

Various types of dog collars illuminated by reflection are known in the art. Representative dog collars of this variety are discussed below.

U.S. Pat. No. 3,871,336 to Bergman discloses a reflective dog collar which is not illuminated; but which utilizes a highly reflective material having the form of different color dots encapsulated in plastic. This illuminates only portions of the flat planar pet collar.

U.S. Pat. No. 3,999,521 to Puiello discloses a reflective safety harness for quadruped animals. The harness includes a pair of identical sheet elements with a light reflective surface mounted on opposite sides of the animal. At the corners of the sheet are fastened straps, which circumscribe the animal's body at the front and rear of the harness. Extending from the front strap, at the top point thereof, midway between the two elements, is a loop through which the dog's regular collar is passed. The arrangement assures immovable attachment of the harness on the dog's body. The disclosure by the '521 patent of a reflective sheet positioned on both sides of the animal does not suggest a pet collar or a leash that reflects incident light.

U.S. Pat. No. 4,167,156 to Kupperman, et al. discloses a reflective animal leather leash. The elongated leather animal leash includes a sewn a transparent polyvinyl chloride strip with a light reflective prism design on one surface. The light reflective prism is bonded by dielectric heat sealing or sonic welding to an opaque polyvinyl chloride strip sewn to the leather strip, resulting in a leash having a light reflective surface. Since the strip has a reflective surface on only one side of the leash, it does not reflect light in every direction. The flat leather leash is not easily twistable and is not readily bent without separating the transparent and opaque polyvinyl chloride layers.

U.S. Pat. No. 4,384,548 to Cohn discloses a safety device for animals. A pet collar uses “retro-reflective” threads with glass reflective elements in a flexible webbing to form a pet leash. The threads are said to reflect incident light directly back toward the source. Disposition of reflective threads in the webbing forming the collar is sparce. As a result, the quantum of incident light reflected is small; and an insignificant quantum of incident light is reflected back to the source.

U.S. Pat. No. 4,407,233 to Bozzaco discloses a safety collar for pets. The collar has highly reflective flexible elements with a length large enough to extend beyond the outer surface of the pet's hair. It uses flexible elements with Scotchlite reflecting strips attached to a collar. A retractable reflective pet leash is not disclosed, and the flexible elements do not reflect light in every direction.

U.S. Pat. No. 5,243,457 to Spencer discloses a material with enhanced visibility characteristics. This flexible visibility enhancing material combines the advantages of a light reflective component and a luminescent component. The material includes a first layer of prismatic light reflective plastic material having an underlying surface formed with a plurality of minute prism-like formations projecting there from at regular spaced intervals, and an overlying substantially smooth light transmissive surface. Bonded, i.e. by heat-sealing, to the first layer is a second layer of plastic luminescent material. The second layer is contiguously and integrally attached to the underlying surface of the prism-like formations and generally coextensive therewith. The visibility enhancing material simultaneously radiates luminescent light from the second layer through the underlying surface of prism-like formations and through the smooth light transmissive surface and reflects light from the prism-like formations through the smooth light transmissive surface. In one embodiment, a leash for controlling and restraining a pet animal includes a flexible elongate member comprised of the visibility enhanced material. In another embodiment, the second layer is replaced with a layer of luminescent material, which can be selectively energized to become luminous. Since the transparent reflective material is a molded plastic of prismatic construction it is rigid and is not flexible and does not form a leash that is capable of being twisted and bent. Further any twisting and bending action separates the reflective element from the luminescent element.

U.S. Pat. No. 5,237,448 to Spencer, et al. discloses a visibility enhancing material. The flexible visibility enhancing material combines the advantages of a light reflective component and a luminescent component. The material includes a first layer of prismatic light reflective plastic material having an underlying surface formed with a plurality of minute prism-like formations projecting therefrom at regular spaced intervals, and an overlying substantially smooth light transmissive surface. A second layer of plastic luminescent material is contiguously and integrally attached to the underlying surface of the prism-like formations and generally coextensive therewith. The visibility enhancing material simultaneously radiates luminescent light from the second layer through the underlying surface of the prism-like formations and through the smooth light transmissive surface, and reflects light from the prism-like formations through the smooth light transmissive surface. In one embodiment, a leash for controlling and restraining a pet animal includes a flexible elongate member comprised of the visibility enhanced material. Since the transparent reflective material is a molded plastic of prismatic construction, it is rigid and is not flexible and does not form a leash that is capable of being retracted, twisted and bent. Furthermore, any twisting and bending action will result in separation of the reflective element from the luminescent element.

U.S. Pat. No. 6,070,556 to Edwards discloses an illuminating dog safety system. This illuminating dog safety system is designed for allowing an animal to be more visible at night. The device includes a collar that is worn around a neck of an animal. The collar has a reflective strip extending a majority of its length. A harness is provided that is adapted to be worn around a torso of the animal. The harness is comprised of an upper strap member, a lower strap member, and a longitudinal extension there between. The upper strap member, the lower strap member, and the longitudinal extension each have a reflective strip extending a majority of a length thereof. A leash is provided that is adapted for securement to the collar. The leash has a reflective strip extending a majority of its length. All these strip elements are made from flat elements, as shown in FIG. 3 of the patent disclosure. Twisting the elements does not provide the reflectivity needed for adequate visibility at night.

Numerous patents disclose reflective materials. Some of these patents disclose reflective elements having corner cube shapes embedded in a rigid or flexible polymeric strips and monolayers of spherical beads, i.e. primarily glass beads bonded to a reflective sheet.

U.S. Pat. No. 3,176,584 to DeVries, et al. discloses that a reinforcing layer may be incorporated into an embedded lens retroreflective sheeting. The reinforcing layer may be of a similar composition as the binder in which the microspheres are embedded. The layer may be applied to the back side of the secularly reflective layer via spraying, i.e., by a solvent-coating technique. Examples of the reinforcing layer materials disclosed include methyl methacrylate, flexible epoxy resins, chloro-sulfonated polyethylene, polystyrene, polypropylene, polycarbonate resin, ethyl cellulose, and cellulose acetate-butyrate. The reflective layer is typically very thin and fragile, i.e. in the order of 0.06 microns thick, and must be disposed in special relationship to the microspheres in order for the sheeting to provide useful retro-reflection.

U.S. Pat. No. 3,190,178 to McKenzie discloses a reflex reflective sheeting. It uses a monolayer of microspheres embedded in a polymer to reflect the incoming light beam in the same direction as the incident beam. Since the sheet is formed by melting of the polymeric binder, it is rigid and therefore unsuitable for flexible pet leashes.

U.S. Patent No. 4,025,159 to McGrath discloses cellular retroreflective sheeting. The cellular retroreflective sheeting comprises a base layer of retroreflective elements and a transparent cover film supported in spaced relation away from the base layer by a network of narrow intersecting bonds. These bonds form hermetically sealed cells within which retroreflective elements are isolated from retroreflective elements of different cells. The resultant sheeting achieves greater durability through use of bonds that are cured in situ after they have been thermoformed into sealing contact between the cover film and base layer. The base material is coated with the binder, subjected to heat and pressure to displace the binder around the embedded microsphers or corner cubes forming the bonded network. Retroreflective articles so constructed may be rigid and inflexible.

U.S. Pat. No. 4,576,850 to Martens, and U.S. Pat. Nos. 4,582,885, 4,668,558 to Barber disclose a shaped plastic articles having replicated microstructure surfaces. This shaped plastic article is made by crosslinked polymer with hard and soft segments having a microstructure-bearing surface that is replicated, with a castable fluid, and radiation hardened. Articles formed by this process exhibit, a retro-reflective cube-corner sheeting, Fresnel lens or video disc. All these formed articles are rigid and therefore unsuitable for use in retractable pet leashes. Moreover, these articles also exhibit low tear strength.

U.S. Pat. No. 4,763,985 to Bingham discloses a launderable retroreflective appliqué that comprises a layer of transparent microspheres, a specular reflective layer optically connected to each microsphere, and a binder layer into which the microspheres are partially embedded. Resins disclosed as being suitable for use as binder layers include polyurethane, polyesters, polyvinyl acetate, polyvinyl chloride, acrylics, or combinations thereof. The specular reflective layers are composed of two succeeding layers of dielectric material. The layers have varying refractive indices and are composed of a variety of binary metal compounds including oxides, sulfides, and fluorides.

U.S. Pat. No. 4,815,818 to Thomas discloses three-dimensional flexible reflectors. The reflector is provided with elastomeric resilient member with a plurality of embedded retro-reflective glass beads. A portion of the outer surface of the elastomeric material is removed to expose the glass beads. The exterior surface of the glass beads at the outer surface is exposed and is subject to abrasion.

U.S. Pat. No. 4,950,525 to Bailey discloses elastomeric retroreflective sheeting. The elastomeric retroreflective sheeting has a monolayer of non-stretchable microspheres. These microspheres are embedded in a sheet with a spacing layer of transparent elestomeric material underlying the back surface of the microspheres. A cover layer of transparent elastomeric material covers the front surface of the microspheres. A specularly reflective layer is disposed on the back surface of the spacing layer. The cover layer comprises a clear thermoplastic elastomeric aliphatic polyurethane.

U.S. Pat. No. 4,957,335 to Kuney discloses microsphere-based retro-reflective articles having high retroreflective brightness at narrow divergence or observation angles, i.e. up to 0.5 degrees. The article is made by selection of microspheres having defined combinations of average diameter and average refractive index. This patent teaches (column 4, lines 18-23) that variation in the size of the microspheres will increase the observation angle or divergence angle of the resultant retro-reflective article.

U.S. Pat. No. 5,066,098 to Kult, et al. discloses cellular encapsulated-lens high whiteness retroreflective sheeting with a flexible cover sheet. This cellular, encapsulated-lens retroreflective sheeting comprises a base sheet of a monolayer of retroreflective elements that is partially embedded in a binder layer which typically is white. A cover sheet is disposed in spaced relation from the layer of retroreflective elements. A network of narrow intersecting bonds, or seal legs, that extend between the cover sheet and the base sheet with binder material are thermoformed at the point of contact between the base sheet and cover sheet. Such a rigid, reflective sheet is unsuitable for retractable pet leashes, which require structures that can twist and flex.

U.S. Pat. No. 5,117,304 to Huang, et al. discloses a retroreflective article. The retroreflective article has corner cubes and is flexible, and can be applied over irregular surfaces by using an optically clear, aliphatic polyurethane polymer. The aliphatic polymer has a plurality of hard chain segments having the formula —C(O)N(H)—C₆ H₁₀—N(H)C(O)—.

U.S. Pat. No. 5,200,262 to Li discloses a launderable retroreflective appliqué. The appliqué employs a reflector that comprises elemental aluminum or elemental silver on the backside of the microspheres. The appliqué comprises a monolayer of metal-coated microspheres partially embedded in and partially protruding from a binder layer. The binder layer comprises a flexible polymer having hydrogen functionalities and one or more isocyanate-functional silane coupling agents. The disclosed flexible polymers that possess hydrogen functionalities are crosslinked, flexible urethane-based polymers, such as isocyanate-cured polymers or one or two component polyurethanes and polyols.

U.S. Pat. No. 5,283,101 to Li discloses a launderable retroreflective appliqué comprising a binder layer formed from an electron-beam curable polymer and typically one or more crosslinkers and silane coupling agents. Electron-beam curable polymers include chlorosulfonated polyethylenes, ethylene copolymers comprising at least about 70 weight percent of polyethylene, such as ethylene/vinyl acetate, ethylene/acrylate, and ethylene/acrylic acid, and poly(ethylene-co-propylene-co-diene) polymers. Glass microspheres are embedded in the cured binder layer, and a specular reflective metal layer is disposed on the embedded portions thereof. When the appliqué is inverted, light comes through the binder layer.

U.S. Pat. No. 5,777,790 to Nakajima discloses a microsphere-based retroreflective article. The retroreflective article comprises a monolayer of microspheres partially embedded in and protruding from a binder layer and specular reflector underlying the microspheres. The monolayer of microspheres comprises a mixture of a first class of microspheres having a first refractive index and a second class of microspheres having a second refractive index. The second refractive index is higher than the first refractive index. As a result, the sheeting exhibits superior observation angle angularity.

U.S. Pat. No. 5,882,796 to Wilson, et al. discloses bonded structured retroreflective sheeting. The structured retroreflective sheeting includes an array of corner cube structured retroreflective elements, a thermoplastic sealing film located proximate the structured elements, and bonding agent between the sealing film and the structured retroreflective elements. The bonding agent bonds the sealing film to the structured retroreflective film. This bonded structure is rigid and is unlikely to survive the flexing and twisting movements of a retractable pet leash.

U.S. Pat. No. 5,926,314 to Smith, et al. discloses a retroreflective cube corner article having scalene base triangles. The cube corner retroreflective article exhibits a wide range of retroreflective entrance angularity in at least one plane, and preferably in two or more planes. The structured surface has an array of cube corner elements formed by three intersecting sets of substantially parallel grooves. Each cube corner element includes a base triangle bonded by one groove from each of the three intersecting groove sets, the base triangle being scalene. The corner cube reflector is rigid and cannot be used for producing reflective leashes.

U.S. Pat. No. 5,962,108 to Nestegard, et al. discloses a retroreflective polymer coated flexible fabric material and method of manufacture. The retroreflective polymeric coated flexible fabric material has a retroreflective layer and a polymeric compatibilizing layer welded to a polymeric coated outer surface of a flexible fabric material. The compatibilizing layer provides an intermediate layer between the retroreflective layer and the flexible fabric material, creating suitable bond strength between dissimilar polymers. Flexible fabric materials are polyester, nylon or cotton. The fabric is coated with highly plasticized polyvinyl chloride (PVC) or ethylene acrylic acid copolymer (EAA). These polymers are flexible, durable, and resistant to abrasion. The retroreflective prismatic elements layer includes: acrylic polymers, such as poly(methylmethacrylate); polycarbonates; cellulosics; polyesters such as poly(butyleneterephthalate); poly(ethyleneterephthalate); fluoropolymers; polyamides; polyetherketones; poly(etherimide); polyolefins; poly(styrene); poly(styrene)co-polymers; polysulfone; urethanes, including aliphatic and aromatic polyurethanes; and mixtures of the above polymers such as a poly(ester) and poly(carbonate) blend, and a fluoropolymer and acrylic polymer blend. The compatibilizing layer that is suitable for bonding between a retroreflective layer and a flexible fabric material include: polyurethane, ethylene methyl acrylate copolymer, ethylene N-butyl acrylate copolymer, ethylene ethyl acrylate copolymer, ethylene vinyl acetate copolymer, polymerically plasticized PVC, and polyurethane primed ethylene acrylic acid copolymer. Such a reflective fabric does not suggest the shape, construction or function of a retractable pet leash.

U.S. Pat. No. 5,910,858 to Frey discloses retroreflective sheeting with a coated back surface. The retroreflective sheet has a plurality of indentations on the back surface to reflect the light, and a transparent front surface to encapsulate and protect the light reflecting indentations. This reflective sheet is rigid and is unsuitable for use in retractable pet leashes, or pet leashed in general.

U.S. Pat. No. 6,159,537 to Crandall discloses a method of making a retroreflective article that has a binder layer containing an epoxy resin and silicone crosslinked polymer. A pre-binder composition comprises about 5 to about 40 parts of an epoxy resin. About 60 to about 95 parts of an alkoxysilane terminated polymer is applied to a retroreflective layer and then cured to form a binder layer that is adhered to the retroreflective layer and an article of clothing. The binder composition does not cover the exterior surface of the reflective layer and does not provide abrasion resistance.

U.S. Pat. No. 6,677,028 to Lasch, et al. discloses retroreflective articles having multilayer films and methods of manufacturing same. These retroreflective articles have multilayer films and are useful for commercial graphics and retroreflective products, such as roll-up signs for highway transportation safety. The articles comprise multilayer films having at least one layer of polyurethane and a core layer of a copolymer of alkylene and a bond layer of non-acidic, polar co-monomer including, ethylene copolymer, vinyl acetate, acrylate, EVA, acid-modified EVA, anhydride-modified EVA, acid-acrylate-modified EVA, anhydride-acrylate-modified EVA, EEA, EMA, AEA, EVACO, EBACO, and EnBA. The glass retroreflective beads comprise an air-exposed portion or have an overlay polyurethane or EAA cover film. When retroreflective glass beads are exposed to air, they are subject to wear.

Notwithstanding the efforts of prior art workers to construct pet leashes, retractable pet leashes, and pet collars that are illuminated by incident light, there remains a need in the art for a flat, braided, omnidirectionally reflective collar and leash that omnidirectionally reflects a significant quantum of incoming light back to its source. Numerous methods for producing retroreflectors have been disclosed. A flexible retractable pet leash having a robust construction that withstands tensile and torsional forces attending leash usage has long been needed in the art. Also needed is a flexible, omnidirectional abrasion resistant retractable pet leash capable of maintaining high reflectivity when subjected to surface abrasion from frictional forces created by contact of the leash with objects having rough exteriors, such as the ground, flooring, posts, trees and the like.

### SUMMARY OF THE INVENTION

The present invention provides a flat, braided, omnidirectionally reflective collar and leash. The leash may be constructed as a leash having a handle portion, central portion, and distal end with a hardware component/portion adapted to operate with a pet collar. In another embodiment, the leash is constructed as a retractable pet leash that is abrasion resistant and omnidirectionally reflective and housed within retractable housing. Omnidirectional reflectivity is provided by the incorporation of retroreflective corner cube reflectors or microsphere reflective elements thermally bonded onto a nylon mesh strip, thread or yarn to form a flexible reflective thread/retroreflective sheet, which is in turn sewn onto a narrow width reflective strip. With this structure, the leash reflects a significant quantum of the incident light from a car head light or other light emitting element back to the source.

The preferred abrasion resistance property of an embodiment of the retractable pet leash is provided by a transparent coating. One such coating comprises a polymer that is transparent, flexible and has a refractive index significantly smaller than that of the retroreflective elements used. Abrasion resistance and omnidirectional reflectivity is achieved by: a) creating a flexible retroreflective sheet comprising a plurality of corner cube reflectors bonded via a transparent bond to a flexible polymeric sheet, or several microspheres bonded via a transparent bond to a reflectorized flexible polymeric sheet; b) producing a narrow width strip composed of nylon or polypropylene fibers by knitting, weaving or braiding, to achieve a strip width in the range of 0.0065 inch to 0.25 inch, depending upon the size of the central rope core; c) thermally bonding a flexible retroreflective sheet onto a nylon mesh strip to form a flexible nylon retroreflective sheet which is in turn sewn onto a show surface of the narrow width strip, thereby forming a narrow width reflective strip; d) braiding, at a shallow braid angle, three or more narrow width reflective strips to form a substantially flat braided omnidirectionally reflective band to thereby create a leash having an external retroreflector surface; and f) preferably coating the external surface of the retroreflective braided band with a transparent, flexible abrasion resistant coating having a refractive index significantly less than that of the retroreflective elements. The thickness of the transparent abrasion resistant coating is in the range of 0.002 to 0.010 inches.

The pet leash has a central section, a proximal end and a distal end. The transparent abrasion resistant coating may be applied to the entire length of the pet leash between the proximal and distal ends (i.e. the central section). In one embodiment, the pet leash is constructed as a retractable pet leash wherein the proximal end of the pet leash is fixedly connected to a reel that is located in an internal chamber of a retractable housing device. The retractable housing device is constructed with a handle portion, a retraction control member actuated by a retraction control switch, a housing body appointed with the internal chamber having the reel member therein mounted, and an extension-retraction aperture. An extension leash may append from the extension-retraction aperture of the retractable housing device. The extension leash is appointed to accommodate a hardware component operable with a pet collar. The proximal end of the pet leash is retained by the reel member so that the proximal end is wrapped around and engages with the reel member. The distal end is attached to the extension leash. The central section of the retractable leash is releaseably spirally arranged within the internal chamber when the retractable leash is in a retracted position. Conversely, the central section of the retractable leash extends from the internal chamber and traverses the extension-retraction aperture when the retractable leash is in an extended position. The extension leash is appointed to accommodate a hardware component operable with a pet collar. Preferably, the extension leash includes reflective properties therein. Most preferably, the extension leash is an omnidirectionally reflective extension leash constructed with a reflective braided extension comprising three or more narrow width reflective strips braided at a shallow braid angle and being operable to surround a central braided extension rope core thereby providing omnidirectional reflectivity to the extension leash. Preferably, the flat reflective braided extension of the omnidirectionally reflective extension leash is substantially coated with a conformal transparent polymeric abrasion resistant coating. Alternatively, the extension leash is composed attached to mechanical hardware, such as a metallic ring, forming a choke collar that encircles the neck of the pet creating a retroreflective collar. In another second embodiment, the extension leash has an adjustable tale or strip with a loop composed of stainless steel or the like, that connects with a pet leash hardware such as a bolt snap that can swivel or not, forming a reflective pet collar that is non-choking. In still another embodiment, the extension leash is provided with a handle portion, which may be composed of fabric (cushioned or not), for better grip and control of the pet. The extension leash is preferably provided with a clasp that is adapted for engagement with a ring-like member on the collar. The collar, itself, is adjustable by maneuvering fabric, and is provided with two mating members which securely lock into place. With this arrangement, the collar can be closed about the neck of the pet by means of a snap-on function.

The character of the flexible flat braided weaved band reflects a significant quantum of incident light back to the source effectively since some portion of the braided weaved band is always at angles close to normality and most of the braided weaved band falls within the reflecting angular range of the retroreflectors. The shallow braiding angle of the braid band lays the thermally bonded narrow width strips at a shallow angle with respect to the length of the central core. As a result the leash can be readily flexed or twisted due to the relative movement provided within the substantially flat braid band structure. The flexibility of the transparent abrasion resistant coating provides for flexing and twisting movement of the abrasion resistant pet leash without coating separation or delamination.

The external surface of the flat retroreflective braided weaved band is coated with a transparent, flexible abrasion resistant polymeric coating. The coating has a refractive index significantly lesser than that of retroreflective elements. Typically the retroreflective elements have a refractive index of 1.9 to 2.2 and the flexible transparent abrasion resistant polymeric coating has a refractive index of 1.3 to 1.55. A 0.002 to 0.010 inch layer of transparent flexible abrasion resistant polymeric coating does not affect the path of normally incident incoming light beam. With such a coating alteration of the path of inclined incident light beam is minimal. Similarly, the reflected light beam path is not severely affected. The internal reflection property of the retroreflective elements is not deteriorated since the abrasion resistant coating has significantly lower refractive index, as compared to that of the retroreflective elements.

In another embodiment the reflective retractable pet leash comprises a substantially flat reflective braided weaved band comprising three or more narrow width reflective threads or strips that are braided at a shallow flat braid angle thereby providing omnidirectional reflectivity. The narrow width reflective strips or threads comprise a woven or knitted narrow width strip and a flexible nylon retroreflective sheet sewn thereon. The woven or knitted narrow width strip has a show surface. The flexible retroreflective nylon sheet comprises a flexible retroreflective sheet thermally bonded onto a nylon mesh strip, and the nylon mesh strip is sewn onto the show surface of the narrow width reflective band. Additionally, the flexible retroreflective sheet has retroreflectors bonded thereto with a transparent bond layer. In an alternative construction, there is used an advanced reflective and coating technology wherein microscopic reflectors are embedded into the braided weave of a fabric. These microscopic reflectors operate collectively to provide a reflective medium that acts like smooth mirrors, enabling reflection of light back to its source. With this construction, the fabric remains supple, facilitating extension and retraction of the leash. One material that has been found to be especially well suited for this purpose is sold by Reflective Technologies Inc. under the tradename IllumiNITE.

Optimal materials found to be especially well suited include reflective materials sold by 3M under the trade names Scotchlite and RetroGlo. Such materials are generally constructed of millions of glass beads (usually titanate glass) or microspheres affixed to a surface or sheet. Each glass bead is preferably covered with a metallic reflective layer on half of its surface (the “back” half) and this, combined with the spherical nature of the glass beads gives the materials reflective properties. Preferably, the glass beads are fixed to a sheet having reflective properties. The microspheres or beads fixed to the sheet/thread are designed to take advantage of the retroreflective optical properties of the glass beads, collecting light from a very wide range of angles of incidence and reflecting the collected light back along a single focused line of sight. When viewing the surface across this line of sight, the surface gives the appearance of reflecting far more light than a normal diffuse reflection imparting nighttime high-visibility safety to the omnidirectionally reflective leash. The flat reflective woven band may be constructed as a collar, a leash, a retractable leash, or a leash choker snap collar, or eyelet collar set. Weaving of the reflective threads for the reflective band is executed in a basket or braided weave, affording different colors and patterns. The band forming the leash provides omnidirectional reflectivity because of the braid, and, or weave, whereby fabric, threads are apparent on either side of the leash. The size of the braid, the weave may vary, and additional reflective threads or yarn can be applied that can be as thin as a pinstripe as the fabric is interwoven into the collar and leash maintaining high “fashion” appeal with enhanced visibility. A reflective yarn may be utilized in conjunction with the reflective threads, may be used independently to form the narrow width reflective strips, or may be used as trim or as enhanced reflective decoration interwoven in the flat reflective band forming the leash. An example of the reflective yarn having applications herein includes that sold by 3M under the trade name RetroGlo. The application of the reflective yarn is designed to further impart increased nighttime safety to the omnidirectionally reflective leash. In general, the reflective yarn is preferably made of reflective material having a plurality of microspheres bonded thereto and laminated to a polyester film for added strength. Preferably, the reflective yarn is made up of 50,000 minute glass beads in each square inch. The material reflects light directly back to a light source, such as a car's headlights. The reflective yarn can be woven, braided or knit into the reflective braided band or into trim applied to the reflective braided band forming the leash. Advantageously, the reflective yarn is substantially unnoticeable in the leash in the daytime, and becomes a brilliant white light reflecting back to a light source at night thereby imparting a separate design shown when light reflects from the leash.

In another embodiment, the reflective retractable pet leash may further comprise a retractable housing device having a handle portion, a retraction control member actuated by a retraction control switch, a housing body with an internal chamber appointed with a reel member, and an extension-retraction aperture. An extension leash is provided, which is appointed to append from the extension-retraction aperture of the retractable housing device and is appointed to accommodate a hardware component operable with a pet collar. Finally, the retractable leash has a central section, a proximal end and a distal end. The proximal end is retained by the reel member so that the proximal end is wrapped around and engages with the reel member, while the distal end is attached to the extension leash. The central section of the retractable leash is releaseably spirally arranged within the internal chamber when the retractable leash is in a retracted position. The central section of the retractable leash extends from the internal chamber and traverses the extension-retraction aperture when the retractable leash is in an extended position.

The reflective pet leash comprises a substantially flat reflective braided woven band made up of reflective threads that are woven at a shallow braid angle. The flat reflective braided weaved band is durable and operable to sustain substantial tensile forces and is constructed to provide omnidirectional reflectivity of 360° regardless of the angle of visibility. The narrow width reflective strips comprise a plurality of reflective threads woven together. The flat reflective braided weaved band has a central section, a proximal end section and a distal end section. The distal end is attached to a hardware portion. The omnidirectionally reflective pet collar and leash is operable to sustain abrasion, substantial tensile forces, and to accommodate twist and flexure forces due to strength and movement afforded by the braided construction of the omnidirectionally reflective braided band. The flat reflective braided weaved band may further comprise braided nylon fibers or polypropylene fibers for enhanced strength. The flat reflective braided woven band is preferably braided at a braid angle of 1 to 10 degrees. Each of the narrow width reflective strips preferably has a width of 0.0065 to 0.25 inches. Preferably, the flat reflective braided woven band is substantially coated with a conformal transparent polymeric abrasion resistant coating. The transparent polymeric abrasion resistant coating preferably has a refractive index in the range of 1.3 to 1.55, and a thickness in the range of 0.002 to 0.010 inches and selected from the group consisting of polyurethane, silicone, polymethyl methacralate, and polyvinyl acetate.

The reflective threads making up the narrow width strips, which in turn are woven or braided to form the flat reflective band, have retroreflectors bonded thereto with a transparent bond layer that are preferably substantially coated with a conformal transparent polymeric abrasion resistant coating. The retroreflectors preferably have a refractive index in the range of 1.9 to 2.2. The narrow width reflective strips may further comprise a plurality of colored threads, and may include a plurality of nonreflective threads mixed in with the reflective threads. The reflective threads can comprise a plurality of corner cube retroreflectors bonded thereto. Preferably, the reflective threads comprise a plurality of microsphere retroreflectors bonded thereto. The reflective threads comprise plurality microspheres comprising a plurality of reflective glass beads that are affixed to a flexible thread. Such threads are offered for sale by 3M under the trade name Scotchlite. Alternatively, reflective threads can comprise a yarn composed of reflective material. Such a reflective yarn is woven, braided or knitted into or applied as trim to the flat reflective braided woven band. A reflective yarn of this type is offered for sale by 3M under the trade name RetroGlo. Braiding of the narrow width reflective strips is executed using a basket or braided weave, whereby different colors and patterns are integrated within the leash.

A reflective pet collar is also provided. The reflective pet collar comprises a substantially flat reflective braided woven band comprising three or more narrow width reflective strips or threads that are at a shallow braided angle. The flat reflective braided woven band is operable to sustain substantial tensile forces and provide omnidirectional reflectivity. The narrow width reflective strips comprise a plurality of reflective threads woven together. The flat reflective braided woven band has a central section, a proximal end section and a distal end section. The distal end is attached to a collar hardware portion adapted to engage with the proximal end, and to close and open the collar around an animal's neck. The omnidirectionally reflective pet collar is operable to sustain abrasion as well as substantial tensile forces. It can accommodate twist and flexure forces due to strength and movement afforded by the braided construction of the omnidirectionally reflective braided band. Preferably, the flat reflective braided woven band is substantially coated with a conformal transparent polymeric abrasion resistant coating.

A process for manufacture of a reflective pet leash or collar is provided. The process comprises the steps of: (i) weaving a plurality of reflective threads together to form narrow width reflective strips; (ii) braiding at least three of the narrow width reflective strips at a shallow braid angle to form a substantially flat omnidirectionally reflective braided woven band that forms a pet leash with omnidirectional reflectivity having a central section, a proximal end and a distal end; and (iii) attaching the distal end of the pet leash to a hardware portion adapted to be operable with a pet collar. The omnidirectionally reflective pet leash is operable to sustain abrasion, substantial tensile forces, and to accommodate twist and flexure forces due to strength and movement afforded by the braided construction of the flat omnidirectionally reflective braided weaved band. The process may further include a step of applying a transparent flexible polymeric abrasion resistant conformal coating to substantially cover the omnidirectionally reflective braided band, and/or forming a handle portion at the proximal end of the leash. Further, the process may include a step for forming a retractable pet leash, including a step of spooling the pet leash within a retractable housing device comprising a handle portion, a retraction control member actuated by a retraction control switch, a housing body with an internal chamber appointed with a reel member, and an extension-retraction aperture, and wherein the reflective pet leash is a retractable leash wherein the proximal end is retained by the reel member so that the proximal end is wrapped around and engages with the reel member, wherein the central section of the retractable leash is releasably spirally arranged within the internal chamber when the retractable leash is in a retracted position and wherein the central section of the retractable leash extends from the internal chamber and traverses the extension-retraction aperture when the retractable leash is in an extended position.

The retractable leash comprises a flat reflective braided weaved band having three or more narrow width reflective threads or strips that are braided at a shallow braid angle thereby providing omnidirectional reflectivity. Each narrow width reflective strip has a flexible nylon retroreflective sheet sewn to their show surface. The flexible nylon retroreflective sheet is formed by thermally bonding a retroreflector coated flexible polymer sheet to a nylon mesh strip.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a.1 is a schematic view of an embodiment of the flat omnidirectionally reflective leash;

FIG. 1a.2 is a top-side view of an embodiment of the flat omnidirectionally reflective collar;

FIG. 1a.3 is a bottom-side view of an embodiment of the flat omnidirectionally reflective collar;

FIG. 1a.4 is a photograph showing a front view of a portion of the central section of the omnidirectionally reflective pet leash/collar taken with camera flash light showing reflective portions as bright regions;

FIG. 1a.5 is a photograph showing a back view of a portion of the central section of the omnidirectionally reflective pet leash/collar taken with camera flash light showing reflective portions as bright regions;

FIG. 2a is a schematic view showing a section of an embodiment of the omnidirectionally reflective pet leash;

FIG. 2b is a colored photograph showing an exploded view of an embodiment of a portion of the central section of the omnidirectionally reflective pet leash taken in the daytime;

FIG. 2c is a colored photograph showing an exploded view of an embodiment of a portion of the central section of the omnidirectionally reflective pet leash taken at night with camera flash light showing reflective portions as bright regions;

FIG. 3 is a photograph of a portion of the central section of the omnidirectionally reflective pet leash illustrating the details of a transparent abrasion resistant polymeric conformal coating substantially covering the reflective braided band of narrow width strips comprised of woven reflective threads and other non-reflective threads;

FIG. 4 is a cross sectional cut-away view of an embodiment of the omnidirectionally reflective pet leash housed within a retraction housing to provide a retractable leash retracted within the retractable housing device, showing a cut-away view of the omnidirectionally reflective retractable pet leash wound around a reel and being retained and housed within the internal chamber of the retractable housing, as when the leash is in a non-extended or [fully] retracted position;

FIG. 5a is a top plane view of another embodiment of the omnidirectionally reflective retractable pet leash, showing the optional extension leash as an omnidirectionally reflective extension leash having omnidirectional reflectivity, and wherein the omnidirectionally reflective retractable pet leash is in the fully retracted position;

FIG. 5b is a cross sectional view showing a portion of the omnidirectionally reflective retractable pet leash extended from the retractable housing device, as when the leash is being extended;

FIG. 5c is a top plane view of cross sectional view of another embodiment of the omnidirectionally reflective retractable pet leash, showing the omnidirectionally reflective extension leash having an end being looped and braided and attached to a hardware component to form a pet collar having omnidirectional reflectivity;

FIG. 6 is a top plane view of an embodiment of the omnidirectionally reflective pet collar; and

FIG. 7 is a schematic view of another embodiment of the omnidirectionally reflective pet collar/leash.

### DETAILED DESCRIPTION OF THE INVENTION

The present invention provides a flat, braided, woven omnidirectionally reflective collar and leash that is flexible, twistable and omnidirectionally reflective. Preferably the flat, braided, woven omnidirectionally reflective collar and leash is abrasion resistant and/or is a retractable pet leash. The flat, braided, woven omnidirectionally reflective collar and leash has a central section, a proximal end and a distal end.

In a first broad embodiment the flat, braided, omnidirectionally reflective leash includes a handle disposed on the proximal end and a hardware component, such as a bolt lock, swivel or not, or the like, disposed on the distal end. Hardware components include the distal end forming a loop with a slidable ring for forming a choke collar integral with the leash or a clip appointed to be removabley clipped onto a pet collar around an animal.

In another broad embodiment the flat, braided, omnidirectionally reflective leash is housed within a retractable housing to yield an omnidirectionally reflective retractable pet leash. The retractable leash is fixedly connected to a reel that is located in an internal chamber of a retractable housing device. The retractable housing device is constructed with a handle portion, a retraction control member actuated by a retraction control switch, a housing body appointed with the internal chamber having the reel member therein mounted, and an extension-retraction aperture. An extension leash appends from the extension-retraction aperture of the retractable housing device. The extension leash of the retractable has a handle portion attached to a non-retractable segment of the leash, which is appointed to accommodate a hardware component operable with a pet collar. The handle is optionally used to hold the pet close at hand, thereby providing an increased measure of control over pet mobility. In a further embodiment, the retractable is provided with a plurality of extension leashes, each of which is associated with a snap clasp or other suitable hardware adapted at the distal end to snap onto the collar of a pet, and which is connected at its proximal end to a ring or suitable component that is not retractable, but attaches to the retractable braided or weaved cord or flat belt, to facilitate walking more than a single pet. The proximal end of the pet leash is retained by the reel member so that the proximal end is wrapped around and engages with the reel member so that the central section of the retractable leash is releaseably spirally arranged within the internal chamber when the retractable leash is in a retracted position. Conversely, the central section of the retractable leash extends from the internal chamber and traverses the extension-retraction aperture when the retractable leash is in an extended position. When the omnidirectionally reflective pet leash is extended from the retractable housing device, as when in use in the extended position, the pet leash omnidirectionally reflects incident light back to its source, thereby clearly defining the pet leash. Moreover, when the extension portion and the pet collar are further provided with omnidirectional reflectivity, the pet leash and the neck portion of the pet that carries the collar are clearly defined by the reflecting incident light. This increases the margin of safety in dusk or night time environments when a car headlight can illuminate the both the pet and the pet owner, reducing the possibility of accidents. Since the omnidirectionally reflecting retractable pet leash reflects light over a broad range, due to its reflective flat band arrangement, the headlight can be at a significant angle and could still be reflected back.

Preferably the flat omnidirectional pet leash includes an abrasion resistant coating, particularly when the pet leash is configured as a retractable leash, so that the reflective integrity does not become diminished due to friction and abrasion on the leash surface. The pet leash is constructed by building a substantially flat reflective band from narrow width strips or threads of nylon or polypropylene. The band includes a top wall, bottom wall and two shallow side walls. The side walls preferably include a reflective strip or reflective yarn extending along the side walls covering the edge/rim of the band or down the center of the band.

The abrasion resistant omnidirectional pet leash is constructed by building a substantially flat reflective band from narrow width strips or threads composed of woven reflective threads and, optionally, reflective yarn, and/or non-reflective threads. Reflectivity is achieved by binding a plurality of retroreflectors using a transparent binder to a fabric or plurality of threads and forming retroreflector coated threads. Each thread is formed having a plurality of glass reflective elements or beads extending along the length thereof bonded thereto with a transparent bond layer. In an alternative construction, there is used an advanced reflective and coating technology wherein microscopic reflectors are embedded into the threads. These microscopic reflectors operate collectively to provide a reflective medium that acts like smooth mirrors, enabling reflection of light back to its source. With this construction, the threads remain supple, facilitating extension and retraction of the leash. At least three of these narrow width reflective strips formed from woven reflective threads are braided at a shallow braid angle to form an omnidirectionally reflective band having a braided construction. The narrow width reflective strips may be comprised of a combination of reflective thread and non-reflective threads.

The retroreflecting elements may be corner cubes, in which case the polymeric flexible sheet can be non-reflective. Alternatively, the retroreflecting elements may be microspheres. If microspheres are used as retroreflective elements, the polymeric flexible sheet needs to be reflective and is typically metalized with aluminum or silver. The flexible sheet with retroreflective elements is available from 3M Corporation. The trade name for this product is 3M™ Radiant Light Films. This product provides films that can be slit to make 0.01″ (0.25 mm) fibers. The product is available in a variety of sizes and colors. Other reflective threads are available from Jinjiang YeShiMing Reflective Material Co., Ltd, under the brand name YSM.

Optimal materials found to be especially well suited include reflective materials sold by 3M under the trade names Scotchlite and RetroGlo. Such materials generally comprise millions of glass beads (usually titanate glass) or microspheres affixed to a surface or sheet. Each glass bead is preferably covered with a metallic reflective layer on half of its surface (the “back” half) and this, combined with the spherical nature of the glass beads gives the materials reflective properties. Preferably, the glass beads are fixed to a sheet having reflective properties. The microspheres or beads fixed to the sheet/thread are designed to take advantage of the retroreflective optical properties of the glass beads, collecting light from a very wide range of angles of incidence and reflecting the collected light back along a single focused line of sight. When viewing the surface across this line of sight, the surface gives the appearance of reflecting far more light than a normal diffuse reflection imparting nighttime high-visibility safety to the omnidirectionally reflective leash. The flat reflective band may be constructed as a collar, a leash, a retractable leash, or a leash choker collar set. Weaving of the reflective threads for the reflective band is executed in a basket or braided weave, affording different colors and patterns. The band forming the leash provides omnidirectional reflectivity because of the braid, and, or weave, whereby fabric, threads are apparent on either side of the leash. The size of the braid, the weave may vary, and additional reflective threads or yarn can be applied that can be as thin as a pinstripe. Such fabric is interwoven into the collar and leash maintaining high “fashion” appeal with enhanced visibility. A reflective yarn may be utilized in conjunction with the reflective threads. It may be used independently to form the narrow width reflective strips, or may be used as trim or as enhanced reflective decoration interwoven in the flat reflective band forming the leash. An example of the reflective yarn having applications herein includes that sold by 3M under the trade name RetroGlo. The application of the reflective yarn is designed to further impart increased nighttime safety to the omnidirectionally reflective leash. In general, the reflective yarn is preferably made of reflective material having a plurality of microspheres bonded thereto and laminated to a polyester film for added strength. Preferably, the reflective yarn is made up of 50,000 minute glass beads in each square inch. The material reflects light directly back to a light source, such as a car's headlights. The reflective yarn can be woven, braided or knitted into the reflective braided band or into trim applied to the reflective braided band forming the leash. Advantageously, the reflective yarn is substantially unnoticeable in the leash in the daytime, and becomes a brilliant white light reflecting back to a light source at night thereby imparting a separate design shown when light reflects from the leash.

The reflective threads are highly flexible and can be worked into a weave to form the narrow width reflective strips, which are then braided at a shallow braid angle to form an omnidirectionally reflective band having a braided construction which substantially sustains the pet-pulling tensile forces. The braiding employs three or more narrow width strips. The braiding is accomplished with a small angle between narrow width strips and the longitudinal direction of the central band. The proximal end of the central band of the leash is fashioned to form a loop representing a handle, and the distal end is formed to go through a metallic loop to create a choke leash. The braiding is accomplished to cover the entire length of the pet leash, including the handle and the choke collar hardware. The ends of the braid are terminated by permanent bonding.

Reflectivity is achieved by first selecting a flexible polymer sheet/thread/yarn and coating the flexible polymer sheet with a plurality of retroreflectors using a transparent binder to form a retroreflector coated flexible polymer sheet. The retroreflector coated flexible polymer sheet is then thermally bonded to a nylon mesh strip to form flexible nylon retroreflective threads; multiple sheets/threads are then grouped to form narrow width reflective strips. At least three of these narrow width reflective strips are braided at a shallow substantially flat braid angle to form the reflective band that in turn forms the leash and/or collar.

The retroreflecting elements may be corner cubes, in which case the polymeric flexible sheet can be non-reflective. Alternatively, the retroreflecting elements may be microspheres. If microspheres are used as retroreflective elements, the polymeric flexible sheet may need to be reflective and is typically metallized with aluminum or silver. Alternatively, the microbe ads may include a coating for reflectivity. The retroreflective elements are bonded to the flexible sheet using a transparent binder.

The flexible sheet with retroreflective elements is available from 3M Corporation. The trade name for this product is SCOTCHLITE and the flexible polymer is typically PVC. A reflective yarn, RetroGlo is also provided by 3M. The product is available in a variety of sizes. The flexible reflectorized sheets may be delivered onto another material by way of utilizing transfer films. These transfer films are composed of retroreflector elements bonded to a variety of heat-activated adhesives. The retroreflector elements include wide angle, exposed retroreflective lenses bonded to a heat activated polyurethane adhesive. The reflective surface is protected by a white paper liner for ease in handling prior to lamination. A plastic liner protects the adhesive side and must be removed before lamination onto the nylon mesh strip. This flexible reflectorized sheet is thermally bonded to a nylon mesh strip, woven or knitted to form a flexible nylon retroreflective sheet. The SCOTCHLITE™ reflective material is composed of wide angle, exposed retroreflective lenses bonded to a heat activated polyurethane adhesive. Alternately, the reflective material is composed of wide angle, exposed retroreflective lenses bonded to durable cloth backing comprised of 65% polyester, and 35% cotton, which is then treated with a polyurethane adhesive and thereby thermally bonded to a nylon mesh strip.

A transparent abrasion resistant coating is applied to the outer surface of the flat reflective braided band of the pet leash and is applied as a substantially conformal coating. The reflective strips have retroreflective threads throughout with corner cube prismatic or microsphere geometry embedded therein. These transparent retroreflective elements may be made from high refractive index transparent materials such as barium oxide-titanium oxide containing glasses. They exhibit a refractive index in the range of 1.9 to 2.2. The transparent abrasion resistant polymeric coating is selected to have a refractive index, which is significantly less than that of the retrorefractive elements. As a result, the incident and reflected light path is not significantly altered even when the incident beam is inclined to the reflective strips. The internal reflection process within the retroreflective elements is not deteriorated by the transparent abrasion resistant coating. The polymers suitable for use with the transparent abrasion resistant coating have a refractive index in the range of 1.3 to 1.55.

In addition to this refractive index requirement, the transparent abrasion resistant coating must exhibit excellent mechanical properties, including tensile strength and elongation, in order to provide the required abrasion resistance. The polymer coating must also exhibit superior bond properties to the retroreflective elements and the underlying polymeric sheet of the reflective strip. If the bond properties are poor, the transparent abrasion resistant coating may delaminate when the pet leash is subjected to abrasion or flexing and twisting movement. The transparent abrasion resistant coating must have low elastic modulus so that it remains flexible when the pet leash is twisted, retracted, extended, and spiraled within the retractable housing device. A high modulus transparent abrasion resistant coating is not desired since it applies significant stresses at the coating—reflective tape interface resulting in deterioration or fracture of the retroreflective elements.

A number of polymer systems meet these requirements. These polymers may be applied by dipping the flat braided pet leash in a polymeric melt or by spraying a polymer composition dissolved in a suitable solvent. Thermosetting resin compositions such as two-component polyurethane may be painted or sprayed over the flat braided reflective outer surface of the pet leash. In Table A below there are listed a number of transparent polymer compositions suitable for the pet leash abrasion resistant coating. Also listed are the refractive indexes for the compositions.

TABLE A

| Polymer Name | Refractive Index |
|---|---|
| aliphatic thermoplastic | 1.35 to 1.45 |
| polyurethanes | |
| Dow Corning OE-4100 | 1.4751 |
| Silicone elastomer | |
| Polymethyl tetradecyl siloxane | 1.4550 |
| Poly vinyl acetate | 1.4665 |
| PMMA Poly methyl | 1.4893 |
| methacrylate | |
| Cellulose acetate | 1.4750 |
| Ethylene/vinyl acetate | 1.4820 |
| copolymer EVA | |

Thermoplastic aliphatic thermoplastic polyurethanes are preferred as compared to aromatic urethanes because of their transparency, resistance to dirt build-up, flexiblility ultraviolet radiation degradation resistance. Typically, aliphatic polyurethane has the structure

[—O—(CH(CH₃)CH2O₂₀—C(O)—NH—R—NH—C(O)—]; or

[—O—(CH₂—CH₂CH₂CH₂—O—)₁₀—C(O)—NH—R—NH—C(O)—], where R is a non-aromatic group.

Rohm and Haas, (Morton International Inc) supplies melt extrudable polyurethane compositions under the trade name designation MORTHANE L430.77 and MORTHANE Brand PN 3429-215. A melt extrusion process may be used to coat the external surface of the flat braided reflective band

Aptec Laboratories, 28570, Livingston Avenue, Valencia Calif. 91355-4171. 661-257-1677 markets polyurethane with low elastic modulus for conformal coatings. Two component APTEK transparent unfilled polyurethane compositions of interest include the composition 2503-A/B (www.apteklabs.com/products/2503-AB.pdf) and the composition 2506-A/B (www.apteklabs.com/products/2506.pdf). These two compositions are designed for the encapsulation and protection of devices in applications that require toughness, excellent flexibility and optimum tensile strength, as well as elongation characteristics. APTEK 2503-A/B is curable at 80 C while APTEK 2506-A/B is room temperature curable. Both compositions are dissolved in a solvent and are therefore suitable for brush or spray application.

Bayer provides a number of clear polyurethane coating compositions based on one component or two component systems. Desmodular I aliphatic diisocyanate is often abbreviated to IPDI, CAS 4098-71-9. Polyurethane prepared from IPDI is clear, tough and resists photodegradation and hydrolysis. Isocyanurate based on IPDI is marketed by Bayer under the trade name Z-4470; and is available in a number of solvent blends. Two component polyurethane is commonly formulated with Desmodur Z-4470. Desmodur E polyisocyanates is a single component moisture curable system capable of being diluted in a solvent.

www.setcochemicals.net/resins4.htm discloses a flexible room temperature curing polyurethane coating designated ROTOTHANE® 9020. This coating adheres to plastics and leather.

Dow Corning supplies a number of silicone compositions suitable for coating the flat braided reflective strips to provide abrasion resistance. Conformal coatings are materials applied in thin layers (typically a few mils or a fraction of a mm) onto printed circuits or other electronic substrates. They provide environmental and mechanical protection to significantly extend the life of the components and circuitry. Conformal coatings are traditionally applied by dipping, spraying or simple flow coating, and increasingly by select coating or robotic dispensing. Key requirements for the clear coating are low viscosity, enabling application of thin conformal coatings, room temperature cure in reasonable cure time and reasonable hardness. In Table B below there are shown some of the conformal silicone coatings marketed by Dow Corning.

TABLE B

| Product | One part/ | Viscosity | | | |
|---|---|---|---|---|---|
| Name | Two part | CPS | Cure | Durometer | |
| 3-1965 | 1 | 110 | RT 24 Hrs | 29 | A |
| | | | Moisture cure | | |
| 3-1953 | 1 | 360 | RT 24 Hrs | 26 | A |
| | | | Moisture Cure | | |
| 3-1765 | 1 | 150 | RT 24 Hrs | 25 | A |
| | | | Moisture cure | | |
| 3-1753 | 1 | 385 | RT 24 Hrs | 25 | A |
| | | | Moisture cure | | |
| Sylgard | 2 | 450 | 20 min/85 C. | 64 | OO |
| 1-4128 | | | | | |
| 1-4105 | 1 | 470 | 10 min/105 C. | 65 | OO |
| QI-4010 | 1 | 830 | 15 min/110 C. | 30 | A |
| 1-2620 | 1 | 250 | RT 72 Hrs | 25 | D |
| | | | | Abrasion | |
| | | | | Resistant | |
| 1-2577 | 1 | 1250 | RT 72 Hrs | 25 | D |
| LOW VOC | | | | Abrasion | |
| | | | | Resistant | |
| 1-2577 | 1 | 725 | RT 72 Hrs | 23 | D |

Abrasion
Resistant

Candidates for silicone conformal coating compositions that meet the low viscosity in the range of 100-250 CPS, room temperature cure in reasonable time period and reasonable hardness are coating compositions 3-1965., 3-1765 and I-2620. These compositions may be dipped, brush painted or sprayed.

Of particular interest is a Dow Corning OE-4100 optical silicone elastomer, which cures in 2 hour at 150 C with a platinum based catalyst, as discussed in www.dowcorning.com/content/photonic/75-1009B-01.pdf. This composition is specifically developed for use in the optical coating of optical components and is clear, transparent with a refractive index of 1.47.

Polyvinyl acetate is soluble in acetone as well as toluene. Acetone dissolved polyvinyl acetate film has a slightly higher elastic modulus as compared to that dissolved in toluene due to rapid evaporation of acetone. Acetone dissolved polyvinyl acetate is applied to the flatly braided surface of the pet leash to form a flexible film which is resistant to twisting action of a pet leash. Polyvinyl acetate is available from Union Carbide under the trade names AYAC, AYAA, AYAF and AYAT depending upon the molecular weight of the polymer.

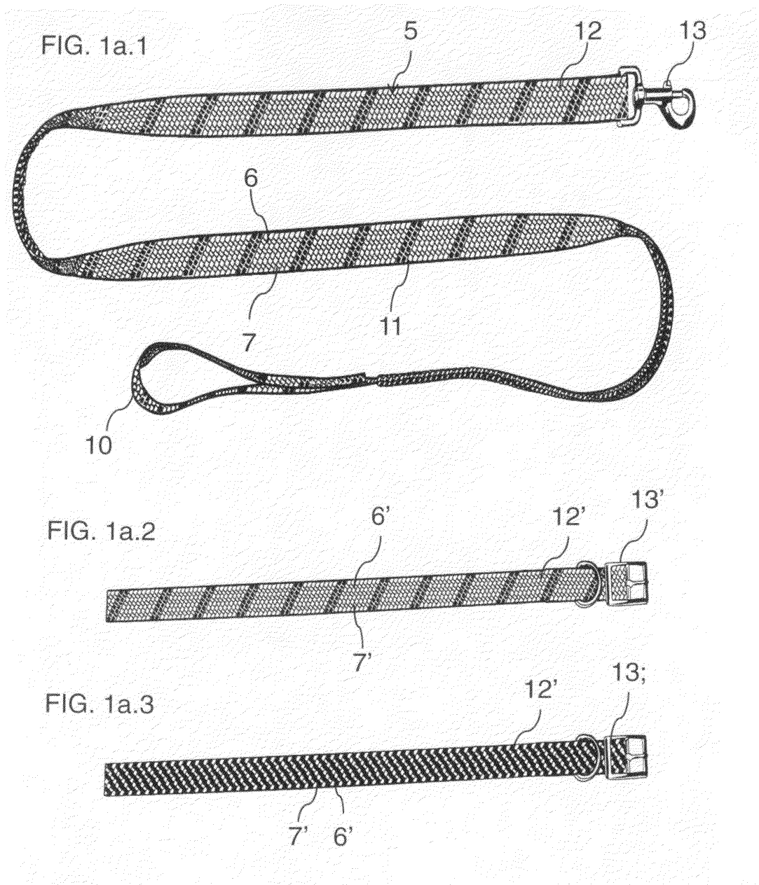

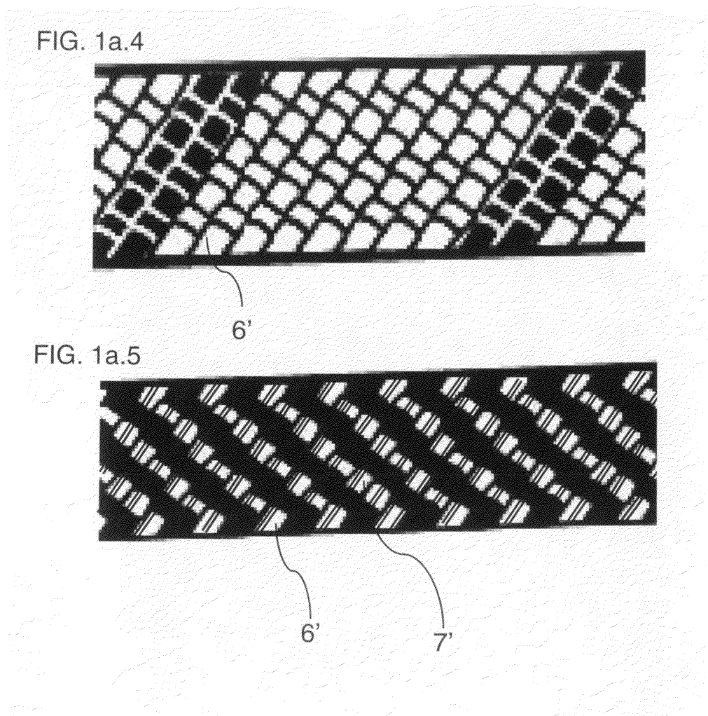

FIG. 1a.1 is a schematic view of an embodiment of the flat omnidirectionally reflective leash. FIG. 1a.2 is a top-side view of an embodiment of the flat omnidirectionally reflective collar. FIG. 1a.3 is a bottom-side view of an embodiment of the flat omnidirectionally reflective collar. FIG. 1a.4 is a photograph showing a front view of a portion of the central section of the omnidirectionally reflective pet leash/collar taken with camera flash light showing reflective portions as bright regions. FIG. 1a.5 is a photograph showing a back view of a portion of the central section of the omnidirectionally reflective pet leash/collar taken with camera flash light showing reflective portions as bright regions.

Referring to FIGS. 1a.1-1a.5, the reflective pet leash/collar comprises a substantially flat reflective braided band 5, 5′ made up of three or more narrow width reflective strips 6, 6′ that are braided at a shallow braid angle. The flat reflective braided band 5, 5′ is durable and operable to sustain substantial tensile forces and is constructed to provide omnidirectional reflectivity of 360° regardless of the angle of visibility. The narrow width reflective strips 6, 6′ comprise a plurality of reflective threads 7, 7′ woven together. The flat reflective braided band has a central section 10,10′ a proximal end section 11, 11′ and a distal end section 12, 12′. The distal end 12, 12′ is attached to a hardware portion 13, 13′. The omnidirectionally reflective pet leash is operable to sustain abrasion, substantial tensile forces, and to accommodate twist and flexure forces due to strength and movement afforded by the woven, braided construction of the omnidirectionally reflective braided band 5, 5′. The flat reflective woven, braided band may further comprise braided nylon fibers or polypropylene fibers for enhanced strength. The flat reflective woven, braided band is preferably braided at a braid angle of 1 to 10 degrees. Each of the narrow width reflective strips 6, 6′ preferably has a width of 0.0065 to 0.25 inches. Preferably, the flat reflective braided band is substantially coated with a conformal transparent polymeric abrasion resistant coating. The transparent polymeric abrasion resistant coating preferably has a refractive index in the range of 1.3 to 1.55, and a thickness in the range of 0.002 to 0.010 inches and selected from the group consisting of polyurethane, silicone, polymethyl methacralate, and polyvinyl acetate.

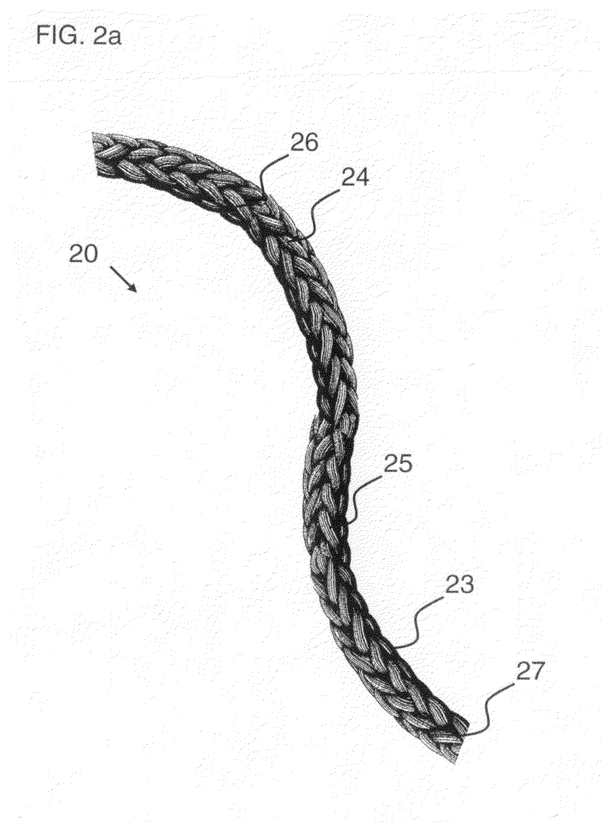

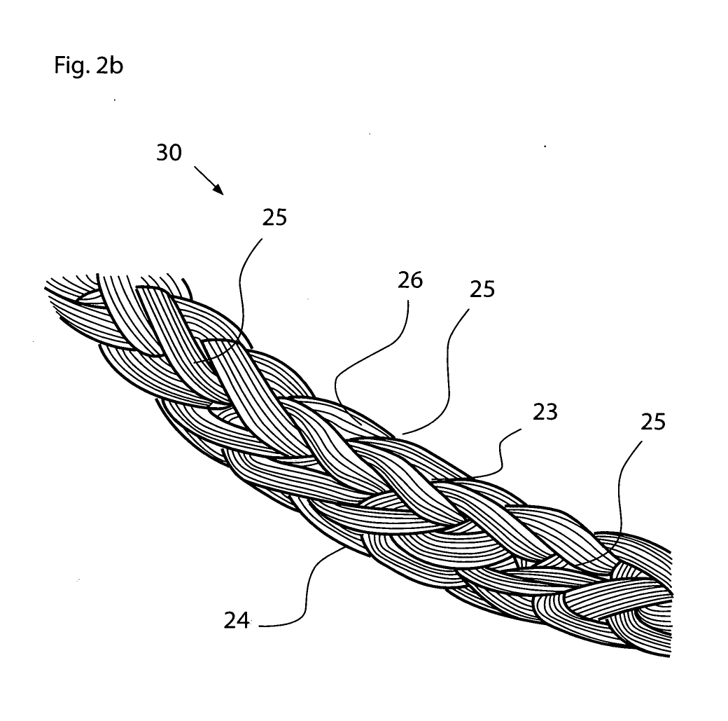

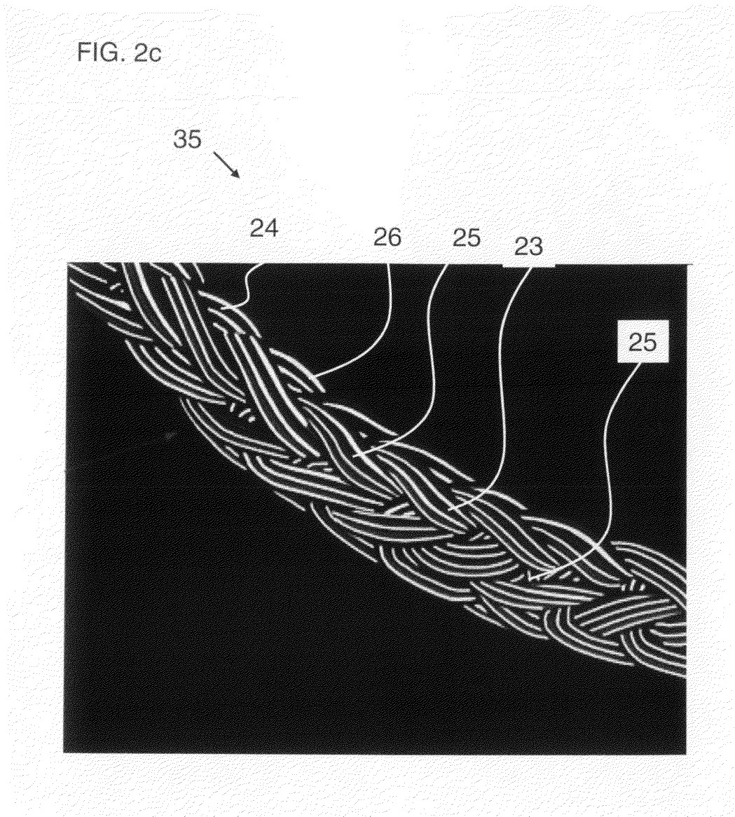

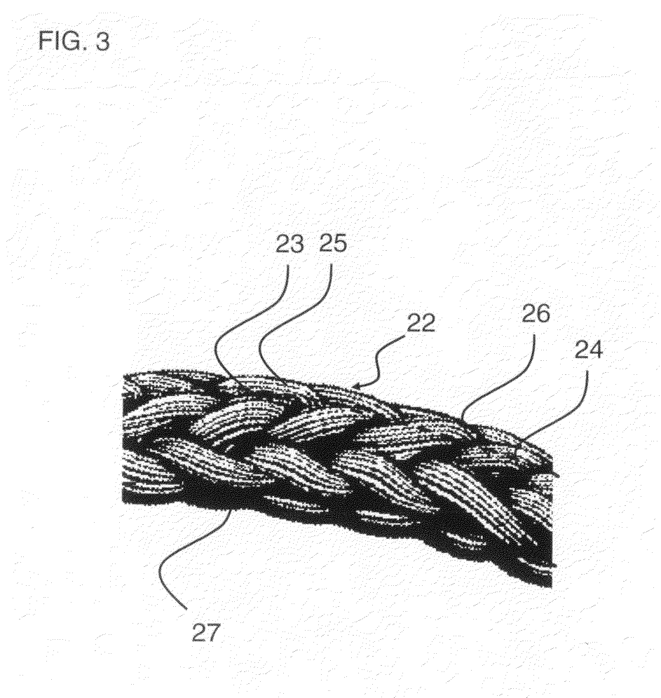

FIG. 2a is a schematic view showing a section of the omnidirectionally reflective retractable pet leash, shown generally at 20. FIG. 2b is a colored photograph showing an exploded view of a portion of the central section of the omnidirectionally reflective retractable pet leash taken in the daytime, shown generally at 30. FIG. 1c is a colored photograph showing an exploded view of a portion of the central section of the omnidirectionally reflective retractable pet leash taken at night with camera flash light showing reflective portions as bright regions, shown generally at 35.

The central section of the omnidirectionally reflective retractable pet leash comprises a flat braided band 23 created from braided narrow width reflective strips 23 each composed of a plurality of reflective threads 26 woven together. The braided band 23 provides omnidirectional reflectivity. This flat braided band 23, created from braided narrow width reflective strips 25, provides substantially the entire surface of the leash with omnidirectional reflectivity. A plurality of reflective threads 26 is woven together, along with colored threads 24 (best seen in FIG. 2b), to form each of the narrow width strips 25.

The retractable leash completely reflects incident light in the same direction the light was emanated. Due to the flat character of the reflective braided band and use of the reflective threads throughout, some portion of the band is always at normal orientation to the incoming light beam, that is, the direction at which the reflection from the retroreflective elements is maximized. Retroreflective elements bonded on the reflective threads 26 reflect light over a large range of acceptance angles, but the reflection is at a lower intensity. This construction effectively reflects the incoming camera flash light as shown in the photograph of FIG. 2c by the extremely bright appearance of the retroreflector threads 26 of the leash. The light here, again, is reflected back to the illuminating source, and practically no light is directed in the direction of the camera.

FIG. 2 is a photograph of magnified portion of the pet leash. The reflective braided band 23 is formed by braiding narrow width reflective strips 25, which are formed of a plurality of reflective threads 26 and colored threads 24 worked into a weave. The narrow width reflective strips 25 are braided with a small braid angle of 1 to 10 degrees, or 5 to 10 degrees, between the narrow width strips 25. The flat reflective braided band 23 is completely made-up of the braided narrow width reflective strips 25, which in turn are made-up of reflective threads and/or reflective yarn 26, imparting omnidirectional reflectivity. Preferably, a transparent abrasion resistant polymeric conformal coating substantially covers the reflective braided band 23 of narrow width strips 25 of reflective threads 26. A plurality of reflective threads 26 is combined with colored threads 24 and worked into a weave to form the narrow width reflective strips 25. The narrow width reflective strips 25 are braided at a shallow flat braid angle to form the omnidirectionally reflective band 23 having a proximal, central, and distal end section of the leash, providing substantially the entire surface of the leash 22 with omnidirectional reflectivity.

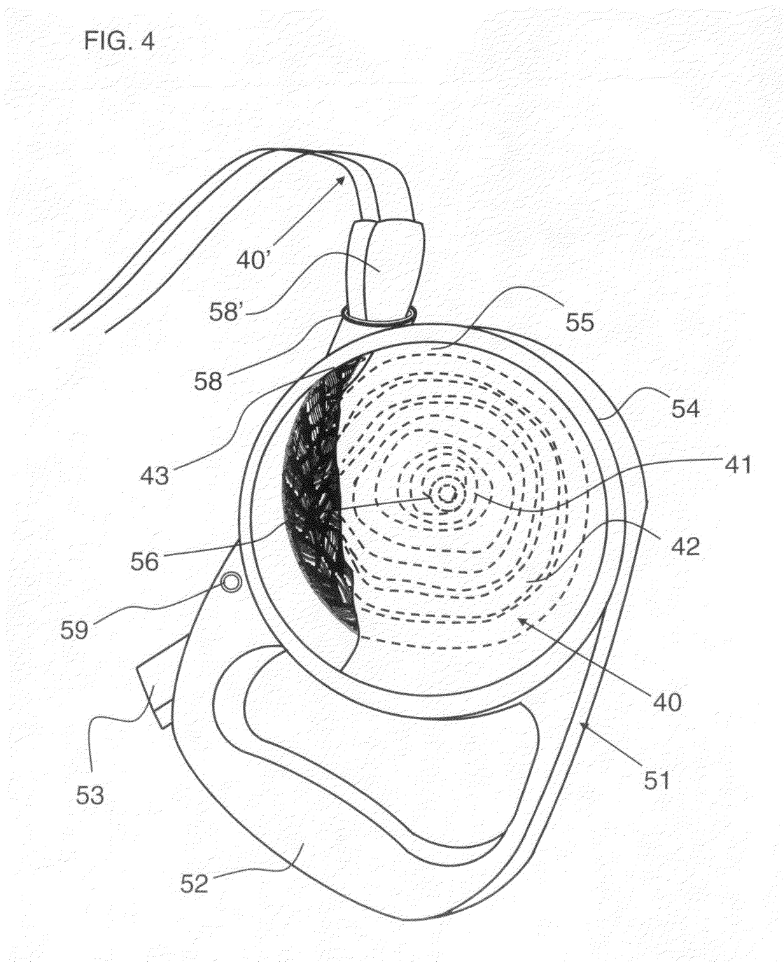

FIG. 4 shows a cut-away cross sectional view of an embodiment of the omnidirectionally reflective pet leash arranged within a retractable housing device to provide an omnidirectionally reflective retractable pet leash. A retractable housing device 51 is provided having a handle portion 52, a retraction control member actuated by a retraction control switch 53, a housing body 55 with an internal chamber 55, and an extension-retraction aperture 58. Generally, the construction of the retractable housing is similar to those heretofore known in the art. Internal chamber 55 is further appointed with a reel member 56. Omnidirectionally reflective retractable pet leash 40 is herein housed or retracted within internal chamber 55 of housing body 54 of retractable housing device 51. Omnidirectionally reflective retractable pet leash 40 includes a proximal end section 41, a central section 42, and a distal end section 43. Retractable housing device 51 may be composed of varying materials; preferably of a polymeric material. Reflective portions or a reflective surface may be applied to retractable housing device 51 so that same has reflective properties.

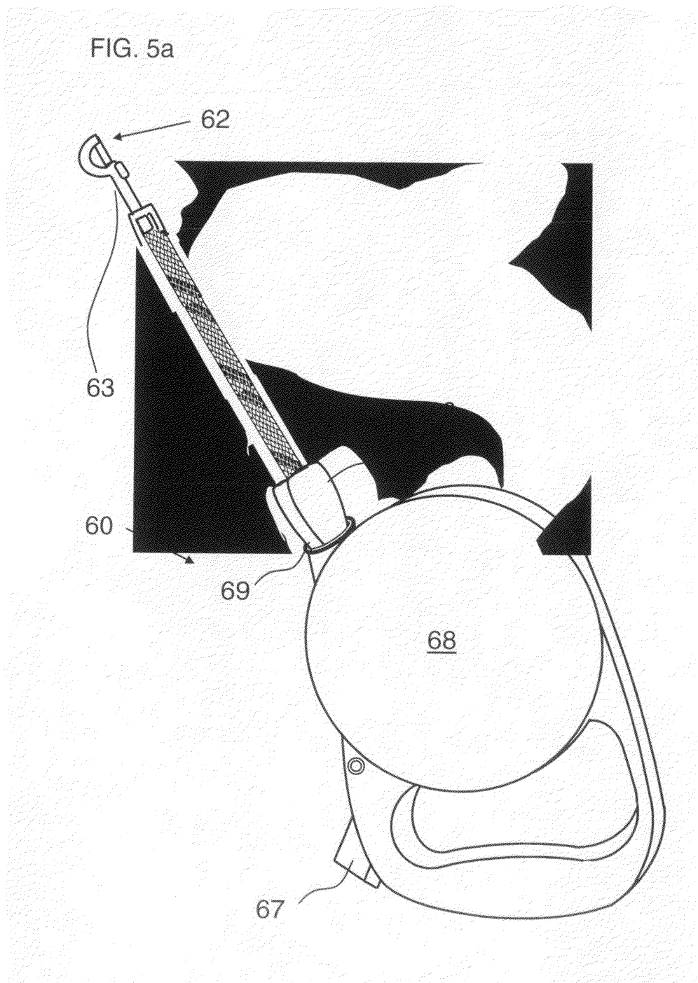

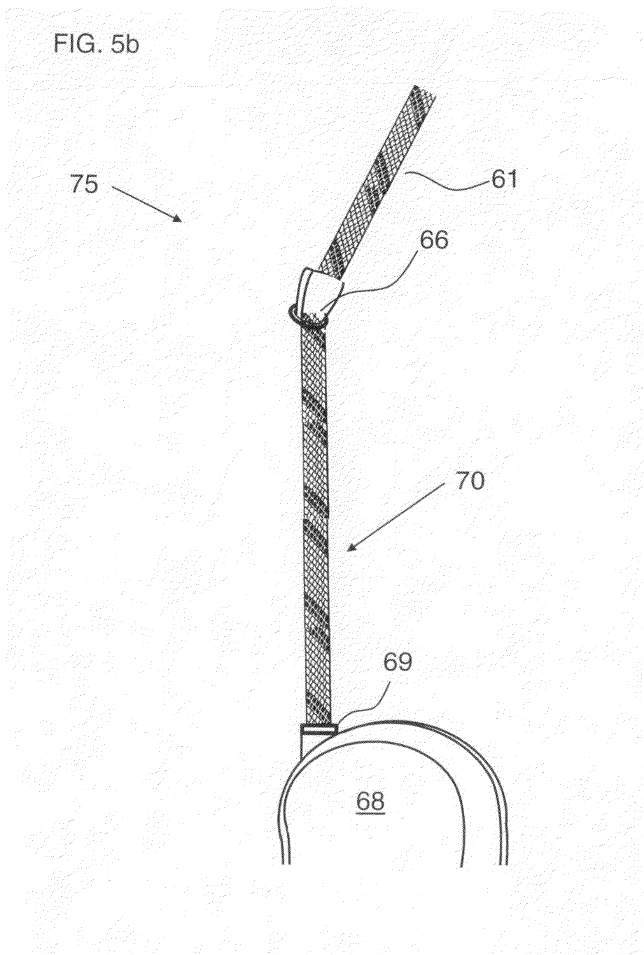

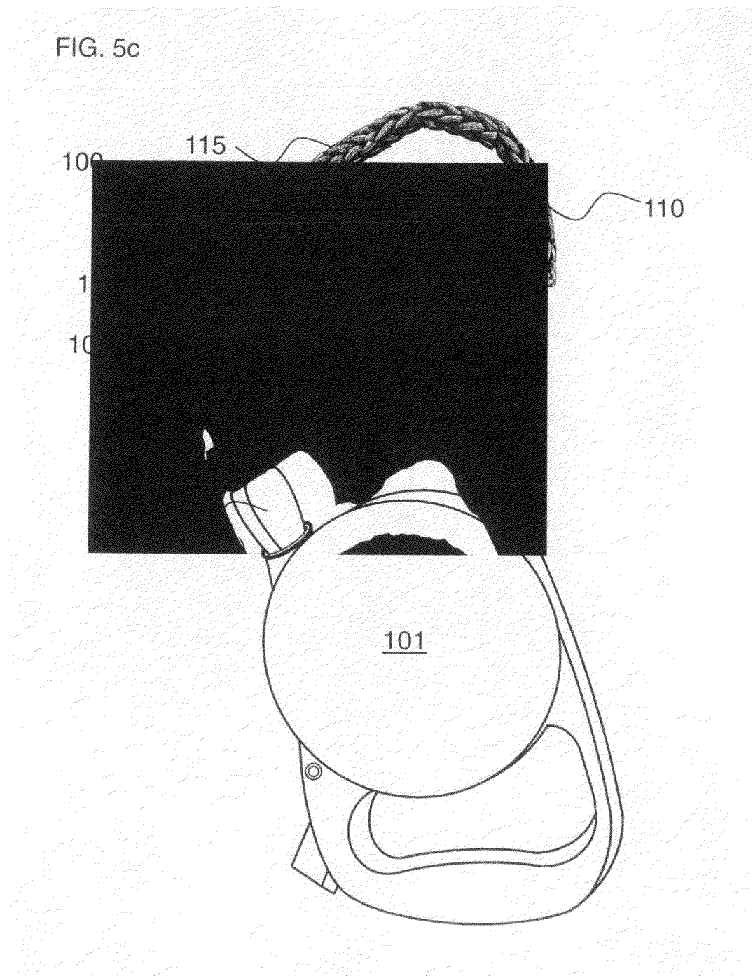

An extension leash 40′ appends from the extension-retraction aperture 58 of retractable housing device 51. Extension leash 40′ is appointed to accommodate a hardware component (not shown in this figure, but see FIG. 5a) operable with a pet collar. Herein extension leash 40′ is shown as a flat leash portion. Preferably, extension leash 40′ includes reflective properties. Extension leash 40′ is fixedly attached to distal end section 43 of omnidirectionally reflective retractable pet leash 40. A stopper 58′ is provided where extension leash 40′ and distal end section 43 mate. Stopper 58′ prevents extension leash 40′ from entering internal chamber 55 of retractable housing device 51. Extension leash 40′ appends from distal end section 43, extension-retraction aperture 58, and stopper 58′.

Proximal end section 41 of retractable pet leash 40 is fixedly connected to reel member 56 located in internal chamber 55 of retractable housing device 51. Retention by reel member 56 of proximal end section 41 of pet leash 40 causes proximal end section 41 to become wrapped around and engage with the reel member 56 so that central section 42 of retractable leash 40 is releasably spirally arranged within internal chamber 55 when the retractable leash is in a retracted position. As the retraction control member actuated by retraction control switch 53 is manually released and pulling force is applied to the extension leash 50, omnidirectional leash 40 is uncoiled and gradually released from internal chamber 55, until retraction control switch 53 is manually engaged to a locking position, thus locking reel member 56 and visa vie omnidirectionally reflective leash 40. A lock 59 is also provided on retractable housing device 51 to place the reel member 56 and visa vie omnidirectionally reflective retractable leash 40 in a locked position preventing further feed or extension and/or retraction of pet leash 40. Portions of central section 42 of retractable leash 40 are released from internal chamber 55 and traverse extension-retraction aperture 58 when retractable leash 40 is in the extended position. Coiling or spiraling of the omnidirectionally reflective leash 40 allows for retract-ability; sizing of the leash 40 may vary.

FIG. 5a is a top plane view of another embodiment of the omnidirectionally reflective retractable pet leash, showing the optional extension leash as an omnidirectionally reflective extension leash having omnidirectional reflectivity, and wherein the omnidirectionally reflective retractable pet leash is in the fully retracted position. FIG. 5b is a cross sectional view showing a portion of the omnidirectionally reflective retractable pet leash extended from the retractable housing device, as when the leash is being extended. FIG. 5c is a top plane view of cross sectional view of another embodiment of the omnidirectionally reflective retractable pet leash, showing the omnidirectionally reflective extension leash having an end being looped and braided and attached to a hardware component to form a pet collar having omnidirectional reflectivity.

In FIG. 5a the omnidirectionally reflective retractable pet leash is in the fully retracted position, housed within the retractable housing device, shown at 60. FIG. 4c shows the omnidirectionally reflective retractable pet leash with a portion thereof extended from the retractable housing device, shown generally at 75. Omnidirectionally reflective extension leash 61 is fixedly attached to omnidirectionally reflective retractable leash 70 via the distal end thereof, at stopper 66, and appends from retractable housing device 68. Omnidirectionally reflective retractable leash 70 is housed when in the fully retracted position. As pulling force is applied to omnidirectionally reflective extension leash 61, and the retraction control switch 67 is manually placed in the unlocked position, omnidirectionally reflective pet leash 70 begins to unwind and traverses extension-retraction aperture 69 as it exits retraction housing device 68. The omnidirectionally reflective retractable pet leash 70 may vary in size from the omnidirectionally reflective extension leash 61 (mm/cm). The omnidirectionally reflective extension leash 61 may have a greater diameter size than omnidirectionally reflective retractable pet leash 70 and the extension-retraction aperture 69. Omnidirectionally reflective pet leash 70 is smaller in diameter that extension-retraction aperture 69 so that the leash 70 can readily pass through extension-retraction aperture 69.

Extension leash is an omnidirectionally reflective extension leash 61 constructed with a flat reflective braided extension band comprising three or more narrow width reflective strips braided at a shallow flat braid angle operable to surround a central flat braided extension band thereby providing omnidirectional reflectivity to the extension leash 61. Preferably, the flat reflective braided extension band of the omnidirectionally reflective extension leash 61 is substantially coated with a conformal transparent polymeric abrasion resistant coating to mitigate damage of the reflective properties.

Hardware component 62, herein shown as a clasp 63 appointed to be releasably connected to a pet collar, is attached to omnidirectionally reflective extension leash 61. The hardware component may vary in structure. The reflective braid is braided around hardware component 62. In another embodiment, hardware component 62 comprises an adjustable metallic tab having a plurality of apertures connected to a pet leash clamp thereby forming a pet collar having non-choke functionality and omnidirectional reflectivity. Alternatively, omnidirectionally reflective extension leash 61 has an end being looped and braided and attached to a hardware component to form a pet collar having omnidirectional reflectivity as is shown in FIG. 5c, shown at 100.

In FIG. 5c, omnidirectionally reflective retractable pet leash (not shown because is in the fully retracted position—what is shown however, is extension leash appending from the distal end of the pet leash) is housed within retractable housing device 101. Omnidirectionally reflective extension leash 102 is fixedly attached to the retracted omnidirectionally reflective retractable leash (not shown) at stopper 106, and appends from retractable housing device 101. Extension leash is constructed herein as an omnidirectionally reflective extension leash 102 structured with a flat reflective braided extension band comprising three or more narrow width reflective strips 115 comprised of a plurality of reflective threads and colored threads. The narrow width reflective strips 115 are braided at a shallow flat braid angle operable to surround a central flat braided extension band thereby providing omnidirectional reflectivity to the extension leash 102. Omnidirectionally reflective extension leash 102 has an end being looped and braided and attached to a hardware component 103 to form a pet collar 110 having omnidirectional reflectivity. The collar 110 is generally of a choker type functioning collar.

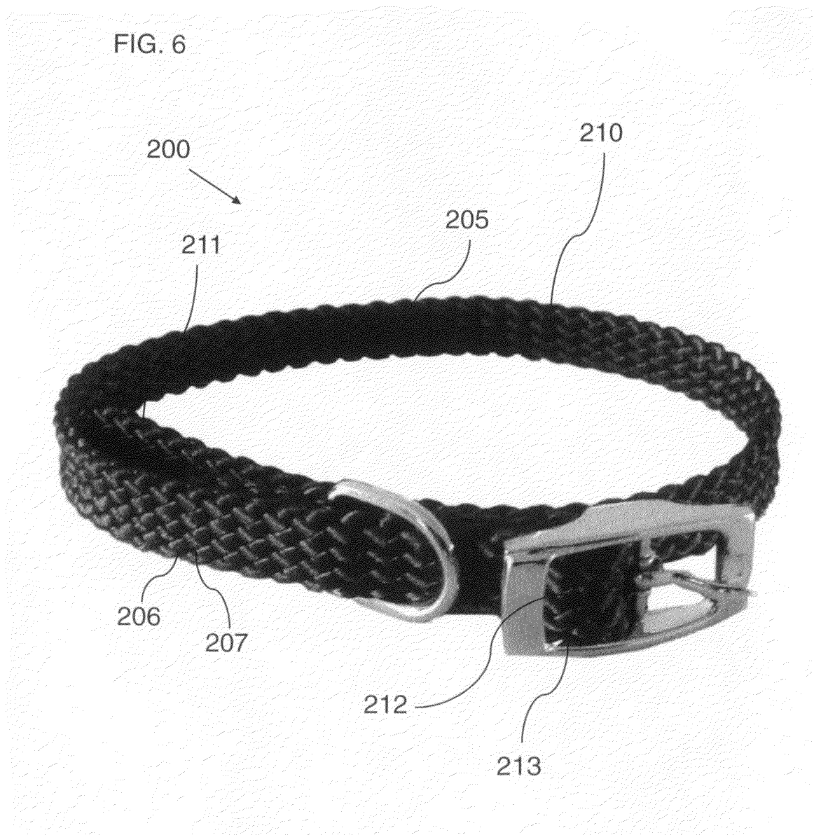

FIG. 6 is a top plane view of an embodiment of the omnidirectionally reflective pet collar, shown generally at 200. The reflective pet collar comprises a substantially flat reflective braided band 205 made up of three or more narrow width reflective strips 206 that are braided at a shallow braid angle. The flat reflective braided band 205 is durable and operable to sustain substantial tensile forces. It is constructed to provide omnidirectional reflectivity of 360° regardless of the angle of visibility. The narrow width reflective strips 206 comprise a plurality of reflective threads 207 woven together. The flat reflective braided band has a central section 210, a proximal end section 211, and a distal end section 212. The distal end 212 is attached to a hardware portion 213. The omnidirectionally reflective pet collar is operable to sustain abrasion, substantial tensile forces, and to accommodate twist and flexure forces due to strength and movement afforded by the braided construction of the omnidirectionally reflective braided band 205.

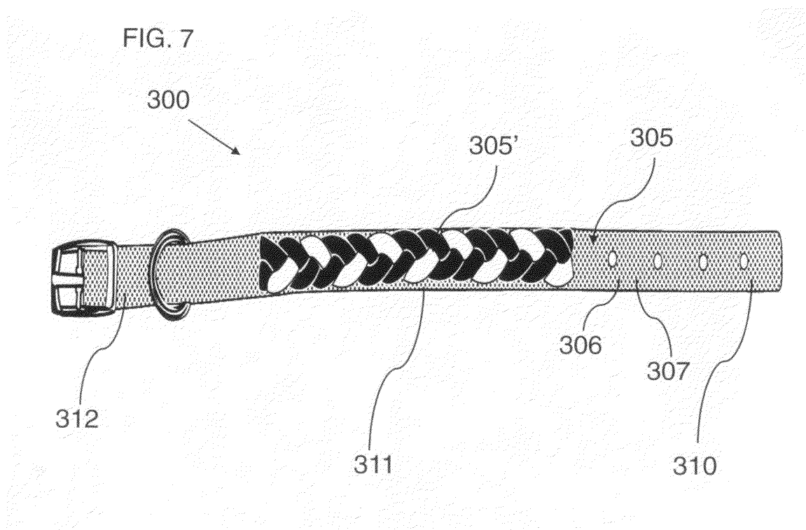

FIG. 7 is a schematic view of another embodiment of the omnidirectionally reflective pet collar/leash, shown generally at 300. In the embodiment shown, the reflective pet collar comprises a flat reflective braided band 305 made up of three or more narrow width reflective strips 306 that are braided at a shallow braid angle. The reflective braided band 305 is constructed to provide omnidirectional reflectivity of 360° regardless of the angle of visibility. A secondary reflective braided band 305′ is centrally attached to the top of the flat reflective braided band 305. The secondary reflective braided band 305′ may be substantially flat or may be cylindrical in nature. Like the flat reflective braided band 305, preferably the secondary reflective braided band 305′ is composed of braided reflective strips comprised of reflective thread to impart reflectivity to secondary band 305′. The narrow width reflective strips 306 comprise a plurality of reflective threads 307 woven together. The reflective braided band 305 has a central section 310, a proximal end section 311, and a distal end section 312. The secondary reflective braided band 305′ acts to project upward from the reflective braided band 305 in a 3D fashion so that the secondary reflective braided band 305′ is visible over the animal's fur as the collar is worn on the neck. Secondary reflective braided band 305′ is mounted on top of the flat reflective strip 306 which, as shown by FIG. 7 is a collar but which may optionally be a leash, as depicted by FIG. 1a. When band 305′ is mounted on the flat portion of strip 306, it creates a half-moon that adds a three-dimensional effect and increased reflectivity. The secondary reflective braided band 305′ can extend for a portion of the collar or leash, or in other embodiments, can extend for substantially the entire length of the article. The height of the raised braided band 305′ increases the area of the band exposed to light, affording increased reflectivity, as well as enhanced protection for the pet and pet handler. Inasmuch as the base of the collar is flat/flat reflective braided weaved band 305, it fits well against the neck of a pet. In addition, the presence of the omnidirectionally secondary reflective braided band 305′ atop the flat reflective braided band 305 better “launches” reflected light (since the braided band 305′ is elevated relative to the pet's fur), improving visibility when walking in dimly lit environments where land vehicles are prevalent. Although a leash is shown, the same structure could be used to construct a flat braided weaved omnidirectionally reflective leash having the strap with a secondary reflective braided band 305′ running centrally thereon. The key features of the flat, braided, weaved omnidirectionally reflective collar and leash include, in combination, the features set forth below:
1. a pet leash comprised of a substantially flat braided weaved reflective band composed of braided narrow width woven reflective strips made-up of reflective threads and/or reflective yarn, nylon or polypropylene fibers capable of sustaining tensile forces developed by pet leash loads;
2. the substantially flat braided weaved reflective band being optionally covered substantially with a transparent abrasion resistant and/or water or insect repellant conformal coating;
3. the substantially flat reflective braided weaved band formed by braiding narrow width reflected threads or strips, formed from knitted, woven or braided reflective threads that can optionally be colored;
4. each of the reflective threads preferably comprising retroreflectors such as corner cube geometry retroreflectors or microspheres;
5. twist and flexure forces acting on the abrasion resistant omnidirectionally reflective pet leash being accommodated by the braided weaved construction of the substantially flat reflective weaved band and the flexibility of an abrasion resistant coating;
6. the substantially flat braided weaved band optionally being a retractable pet leash substantially reflecting incident light back in the same direction as the incident light, clearly indicating the whereabouts of the pet leash handle, pet leash central portion, and the pet leash collar surrounding the neck; and
7. the abrasion resistant omnidirectionally reflective retractable pet leash providing an increased margin of safety for pets and their owners while walking in dimly lit environments, such as parking garages, or inclement weather conditions, where moving land vehicles are encountered.

The flat, braided, weaved omnidirectionally reflective collar and leash disclosed herein can be modified in numerous ways without departing from the scope of the invention. For example, at least one strip of the central braided band can be composed of leather. The pet leash/pet collar can include a central rope core. A poly-phosphorus coating can be applied to further enhance visibility of the omnidirectionally reflective, flat collar or leash. These and other modifications are intended to fall within the scope of the invention, as defined by the subjoined claims.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A reflective pet leash, comprising:
a. a substantially flat reflective braided band comprising three or more narrow width reflective strips that are braided at a shallow braid angle, said flat reflective braided band being operable to sustain substantial tensile forces and provide omnidirectional reflectivity;
b. said narrow width reflective strips comprising a plurality of reflective threads woven together;
c. said flat reflective braided band having a central section, a proximal end section and a distal end section, said distal end being attached to a hardware portion;
wherein said omnidirectionally reflective pet leash is operable to sustain abrasion, substantial tensile forces, and to accommodate twist and flexure forces due to strength and movement afforded by said braided construction of said omnidirectionally reflective braided band.

2. A reflective pet leash as recited by claim 1, wherein said flat reflective braided band comprises braided nylon fibers.

3. A reflective pet leash as recited by claim 1, wherein said flat reflective braided band comprises braided polypropylene fibers.

4. A reflective pet leash as recited by claim 1, wherein said flat reflective braided band is braided at a braid angle of 1 to 10 degrees.

5. A reflective pet leash as recited by claim 1, wherein each of said narrow width reflective strips has a width of 0.0065 to 0.25 inches.

6. A reflective pet leash as recited by claim 1, wherein said flat reflective braided band is substantially coated with a conformal transparent polymeric abrasion resistant coating.

7. A reflective pet leash as recited by claim 6, wherein said transparent polymeric abrasion resistant coating has a refractive index in the range of 1.3 to 1.55.

8. A reflective pet leash as recited by claim 6, wherein said transparent polymeric abrasion resistant coating has a thickness in the range of 0.002 to 0.010 inches.

9. A reflective pet leash as recited by claim 6, wherein said transparent polymeric abrasion resistant coating polymer is a member selected from the group consisting of polyurethane, silicone, polymethyl methacralate, and polyvinyl acetate.

10. A reflective pet leash as recited by claim 1, wherein said reflective threads have retroreflectors bonded thereto with a transparent bond layer.

11. A reflective pet leash as recited by claim 10, wherein said reflective threads are substantially coated with a water resistant compound and a poly-phosphorus coating that further enhances visibility thereof.

12. A reflective pet leash as recited by claim 10, wherein said retroreflectors have a refractive index in the range of 1.9 to 2.2.

13. A reflective pet leash as recited by claim 1, wherein said narrow width reflective strips further comprise a plurality of colored threads.

14. A reflective pet leash as recited by claim 1, wherein said narrow width reflective strips further comprise a plurality of nonreflective threads.

15. A reflective pet leash as recited by claim 1, wherein said reflective threads comprise a plurality of corner cube retroreflectors bonded thereto.

16. A reflective pet leash as recited by claim 1, wherein said reflective threads comprise a plurality of microsphere retroreflectors bonded thereto.

17. A reflective pet leash as recited by claim 1, wherein said reflective threads comprise a plurality microspheres comprising a plurality of reflective glass beads that are affixed to a flexible thread.

18. A reflective pet leash as recited by claim 1, wherein said reflective threads comprise a reflective yarn made of reflective material, wherein said reflective yarn is sewn, woven, braided or knitted into or applied as trim to said flat reflective braided band.

19. A reflective pet leash as recited by claim 1 comprising a secondary band adapted to rest atop the braided band, said secondary band comprising braided reflective strips composed of reflective thread and creating on said leash a raised portion that increases the area of the band exposed to light, thereby increasing reflectivity and visibility of said leash.

20. A reflective pet leash as recited by claim 1, wherein said narrow width reflective strips braiding is executed in a basket or braided weave, affording different colors and patterns integrated within said leash.

21. A reflective pet leash as recited by claim 1 comprising a retractable housing device having a handle portion, a retraction control member actuated by a retraction control switch, a housing body with an internal chamber appointed with a reel member, and an extension-retraction aperture, and wherein said reflective pet leash is a retractable leash wherein said proximal end is retained by said reel member so that said proximal end is wrapped around and engages with said reel member, wherein said central section of said retractable leash is releasably spirally arranged within said internal chamber when said retractable leash is in a retracted position and wherein said central section of said retractable leash extends from said internal chamber and traverses said extension-retraction aperture when said retractable leash is in an extended position and wherein said distal end extends from said extension-retraction aperture of said retractable housing device.

22. A reflective pet leash as recited by claim 21, wherein said distal end of said retractable leash comprises an extension leash, said extension lease being appointed to append from said extension-retraction aperture of said retractable housing device and being appointed to accommodate said hardware component operable with said pet collar.

23. A reflective pet leash as recited in claim 1, wherein said proximal end of said leash includes a handle portion.

24. A reflective pet leash as recited in claim 1 comprising a secondary reflective braided band attached to said flat reflective braided band.

25. A reflective pet leash as recited in claim 24, wherein said secondary reflective braided band has a half-moon configuration and is composed of at least three braided reflective strips comprised of a plurality of reflective threads woven or stitched together and applied to said flat reflective braided band by gluing or sewing or plastic staples or studs to impart reflectivity to said secondary band.

26. A reflective pet leash as recited in claim 24, wherein said secondary reflective braided band is, optionally, multi-colored and is substantially cylindrical and composed of at least three cylindrically braided reflective strips comprised of a plurality of reflective threads woven together to impart reflectivity to said secondary band.

27. A reflective pet collar, comprising:
a. a substantially flat reflective braided band comprising three or more narrow width reflective strips that are braided at a shallow braid angle, said flat reflective braided band being operable to sustain substantial tensile forces and provide omnidirectional reflectivity;
b. said narrow width reflective strips comprising a plurality of reflective threads woven or sewn together;
c. said flat reflective braided band having a central section, a proximal end section and a distal end section, said distal end being attached to a collar hardware portion adapted to engage with said proximal end appointed to close and open said collar around an animal's neck.
wherein said omnidirectionally reflective pet collar is operable to sustain abrasion, substantial tensile forces, and to accommodate twist and flexure forces due to strength and movement afforded by said braided construction of said omnidirectionally reflective braided band.

28. A reflective pet collar as recited by claim 27, wherein said flat reflective braided band is substantially coated with a water resistant compound, a conformal transparent polymeric abrasion resistant coating and a poly-phosphorus coating to enhance visibility, as well as wear and water worthiness thereof.

29. A process for manufacture of a reflective pet leash, comprising the steps of:
a. weaving or sewing a plurality of reflective threads together to form narrow width reflective strips;
b. braiding at least three of said narrow width reflective strips at a shallow braid angle to form a raised portion atop a substantially flat omnidirectionally reflective woven band to form a pet leash with omnidirectional reflectivity having a central section, a proximal end and a distal end;
c. attaching said distal end of said pet leash to a hardware portion adapted to be operable with a pet collar;
wherein said omnidirectionally reflective pet leash is operable to sustain abrasion, substantial tensile forces, and to accommodate twist and flexure forces due to strength and movement afforded by said braided construction of said flat and raised omnidirectionally reflective woven bands.

30. A process for manufacture of a reflective pet leash as recited in claim 29 including a step of applying a transparent flexible polymeric abrasion resistant conformal coating to substantially cover said omnidirectionally reflective braided band.

31. A process for manufacture of a reflective pet leash as recited in claim 29 including a step of forming a handle portion at said proximal end of said leash.

32. A process for manufacture of a reflective flat belt pet leash as recited in claim 29 including a step of spooling said pet leash within a retractable housing device comprising a handle portion, a retraction control member actuated by a retraction control switch, a housing body with an internal chamber appointed with a reel member, and an extension-retraction aperture, and wherein said reflective flat belt pet leash is a retractable leash wherein said proximal end is retained by said reel member so that said proximal end is wrapped around and engages with said reel member, wherein said central section of said retractable flat belt leash is releaseably spirally arranged within said internal chamber when said retractable leash is in a retracted position and wherein said central section of said retractable flat belt leash extends from said internal chamber and traverses said extension-retraction aperture when said retractable flat belt leash is in an extended position.
